(19) United States
(12) Patent Application Publication
(10) Pub. No.: US 2007/0184238 A1
(43) Pub. Date: Aug. 9, 2007

(54) Laminate actuators and valves

(75) Inventors: Robert G. Hockaday, Los Alamos, NM (US); Patrick S. Turner, Los Alamos, NM (US); Marc D. DeJohn, Santa Fe, NM (US); Liviu Popa-Simil, Los Alamos, NM (US); Laura A. Hockaday, Los Alamos, NM (US)

Correspondence Address: JAMES C. WRAY, 1493 CHAIN BRIDGE ROAD, SUITE 300, MCLEAN, VA, 22101, US

(73) Assignee: Energy Related Devices, Inc.

(21) Appl. No.: 11/702,821

(22) Filed: Feb. 6, 2007

Related U.S. Application Data
(60) Provisional application No. 60/765,607, filed on Feb. 6, 2006.

(51) Int. Cl. B32B 5/00; A41F 9/00; B32B 7/00

(52) U.S. Cl. 428/98; 2/1

(57) ABSTRACT

Artificial stoma formed with multilayered structures that actuate with humidity, temperature, chemical environment or light. These actuators can be incorporated into shoes, apparel, fuel cells, machinery, and buildings to control fluid flow or diffusion to regulate humidity, temperature, chemical environment, or light. These actuators can be used as sensors, modify structure, or appearance for greater function, comfort, or aesthetics.

This application claims the benefit of U.S. Provisional Application No. 60/765,607 filed Feb. 6, 2006.

### BACKGROUND OF THE INVENTION

The development of devices that are functional over a wide range of environments, such as apparel, fuel cells, and catalytic heaters, has led to the need to regulate the diffusion and flow of fluids, moisture, volatile gases, and temperature. This in turn has led to an aperture control device to regulate the diffusion or flow of reactants across a barrier to control humidity, molecular content, or temperature of a space. In most cases this is a planar barrier but in a few cases the barrier is a polymorphic surface barrier between to volumes or a surface and a volume such as the air and skin of a human. In the past we have used a selectively permeable membrane to regulate moisture to the surface of skin of a human or regulated the delivery of fuel to a catalytic burner or fuel cells, but these membranes do not offer the dynamic range that can be obtained with opening and closing of apertures. Utilizing apertures leads to greater dynamic range in performance and can lead to better performance of said applications. In animal and plant systems there are examples of moisture and heat actuating and regulating systems. Probably the best known are the stoma on plants and pores of human skin which regulate the water content and temperature inside leaves by opening when hot or high water content and closing when water content is low.

### SUMMARY OF THE INVENTION

The basic components of this invention are:
Laminate or bi-material actuated mechanical assemblies that are built as part of a membrane or structure.
Laminate actuated mechanical assemblies that actuate on humidity and/or temperature.
Porous membranes or barrier with apertures
Multiple membranes with random defined apertures.
Multiple membranes with non-random apertures.
Reactive components to produce the mechanical motion and control mass transfer.
Changes in presence of chemical vapor changes other than water and actuates mechanical motion or controls opening and closing of apertures.
Temperature changes produce the mechanical motion and opening or closings of apertures.
Differential pressure across the barrier produces the mechanical closing or opening force.
Light interacts with the actuator producing opening or closing.
Electrical interactions with the actuator producing motion or force.
The aperture membranes have voids between them. When there are voids between the membranes there is low resistance to the diffusion or flow of fluids. When the aperture membranes are compressed together to touch or be near touching the fluid flow or diffusion resistance is high.
Adjacent membranes have a bumpy texture to separate themselves. Intervening membranes may be permeable and chemically reactive and may also provide the separating force mechanism that separates two aperture membranes
A plethora of small actuating valves in sheet form to control flow or diffusion.
Intrinsic indirect or baffled flow routes to block sharp objects and particulates.
Combined with filters to capture or repel particulate.
Combined with chemical reactants and coatings such as titanium oxide and activated charcoal to react with the fluid.
Combined with wicking materials and water absorbents.
Mechanically or electrically coupled actuators to actuate valves, create indicators, sensors, or interact with electrical devices.
   EMBODIMENTS OF THE INVENTION:

A simple example of a laminate actuator composed of two materials (bi-material actuation) one that swells when exposed to high humidity and another that does not. The two materials are joined, as planar layers at low humidity conditions. When this laminate is exposed to high humidity, the swelling layer expands. This expansion is constrained on one side by the non-expanding sheet. This asymmetric expansion of the laminate causes the layered sheet to bend. If the bending is constrained it will result in a curling force from the layered sheet.

Several other material expansion and contraction effects can be used to create laminate actuators. Multiple layers and multiple actuators can also be used to create desirable characteristics. If an expansion or contraction effect in a material is known, laminate and bi-material actuators performances can be predicted. Currently the data most available on material expansion is from humidity and temperature effects. So humidity and temperature actuators are the most convenient to predict and engineer into actuators. To predict the basic performance of humidity or temperature bi-material systems the following sample study of material properties was done.

Humidity Expansion Material Component

Definitions:

Humidity Coefficient Expansion: is the fraction expansion of a material per unit of relative humidity change. It can be expressed also as a percentage expansion divided by percentage change in relative humidity.

Modulus of Elasticity: is the internal pressure in a material (stress) when that material is compressed or stretched a fraction of its original dimensions (strain).

We define a figure of merit for the humidity expanding materials as Humidity Modulus as: Humidity Coefficient Expansion X Modulus of elasticity=Humidity Modulus (pressure/relative humidity)

Tensile Strength: is the maximum internal pressure (stress) that the material can reach before yielding in tension.

Materials:

| | | | Product of humidity | |
|---|---|---|---|---|
| | Humidity | | coefficient of | |
| | Coefficient of | Modulus | expansion times the | |
| | Expansion | of | tensile modulus | |
| | (% expansion/ | Elasticity | (GPa/% relative | Tensile |
| | relative | (GPa) (in | humidity) (Humidity | Strength |
| Material | humidity) | tension) | Modulus) | (MPa) |
| Nafion | 0.19 | 0.31 | 0.059 | 36 |
| DAIS | 0.06 | 0.06 | 0.036 | 23 |
| Cellulose | .019-.065 | .68-2.8 | .013-.18 | 13-57 |
| Acetate | | | | |
| Nylon-6 | .027 | 1.8-2.8 | .049-.076 | 48-82 |
| Polyimide | .000022 | 2.9 | .000064 | 241 |
| Polyester | .000012 | 3.9 | .000047 | 206 |
| Polyaramid | .000025 | 14.7 | .00037 | 245 |
| Polyimide | 0.002 | >47 | .094 | 234 |
| 50% glass | | | | |
| fiber | | | | |

The typical humidity actuator is composed of two materials: the substrate material being porous polyimide, with a high modulus of elasticity and unaffected by humidity. The second material such as Nafion or DAIS typically has a modulus of elasticity at least 10 times lower than the substrate material and has a high humidity modulus.

The force from a single linear element is proportional to the humidity coefficient of expansion times the modulus of elasticity times the change in humidity. The product of the humidity coefficient of expansion times the modulus of elasticity is a useful figure of merit for identifying and comparing materials suitable for actuators.

The bi-material laminate shear force is proportional to the difference in humidity coefficient of expansion times the modulus of elasticity times the change in humidity. The practical result is that the higher the force than can be obtained per unit of relative humidity change, the higher the capability of the actuator to overcome resistive forces such as friction and gravity.

The radius of curvature of a bi-material strip due to a humidity change is proportional to the thickness of the materials divided by the difference in humidity coefficients of expansion and the change in relative humidity. The practical result is that small radius of curvature actuation is obtained by using thin substrates and high humidity coefficients of expansion. The amount of actuation (curl or rotation) is proportional to the difference in the humidity coefficients of expansion of the two materials and the change in relative humidity. When working against a force, the amount of actuation (curl or rotation) is proportional to the humidity modulus times the change in relative humidity and thickness.

Another feature of thin layered material is that the diffusion rate through the thin layer is rapid. If the substrate material is porous it also allows diffusion access and the actuation rate can be almost doubled.

Temperature Expansion Material Component

Definitions:

Thermal Coefficient of Expansion: Percentage of expansion coefficient per temperature change.

| | Thermal | | Thermal Elastic |
|---|---|---|---|
| | Coefficient of | Modulus of | Modulus |
| Material | Expansion | Elasticity (MPa) | (MPa/° C.) |
| Crystalline | 71 × 10⁻⁵/° C. | >400 | >.3 |
| Polyacrylates | | | |
| Low Density | 10-20 × 10⁻⁵/° C. | 97-262 | .0097-.052 |
| Polyethylene | | | |
| Polyester glass | 1.8-3 × 10⁻⁵/° C. | 3,450-10,300 | .062-.30 |
| reinforced | | | |
| Polyimide | 5 × 10⁻⁵/° C. | 2,900 | .15 |
| Polyaramid | 0.2 × 10⁻⁵/° C. | 14,700 | .029 |
| Polyester | −18.0 × 10⁻⁵/° C. | 3900 | −0.70 |
| (Melinex) | | | |

The force from a single linear element is proportional to the thermal elastic modulus times the change in temperature.

The bi-material composite layer shear force is proportional to the difference in coefficient of expansion times the modulus of elasticity times the change in temperature. The practical result is the higher the force than can be obtained per unit of temperature the higher the coefficient of expansion difference times the modulus of elasticity and the actuators ability to overcome resistive forces such as friction and gravity.

The radius of curvature of a bi-material strip (structure) due to a temperature change is proportional to the thickness of the layers divided by the difference in thermal expansion coefficient and the change in temperature. The practical result is that small radius of curvature actuation is obtained by using thin layers and low modulus of elasticity. The amount of actuation (curl) is proportional to the difference in the coefficient of expansion and the change in temperature. In other words the rotation of an actuator, flap, or door is proportional to the temperature and the difference in the coefficients of expansion. The force of that actuator will be proportional to the difference in coefficients of expansion, the temperature difference, the thickness of the materials, and the modulus of elasticity of each.

The thinner systems have a faster response time to changes in temperature because of the lower heat capacity.

Other Expansion Material Components

Other systems of actuation with a change in chemical environment or delivered electromagnetic energy should follow similar relationships to the temperature and humidity actuation if the environmental change causes differential expansion or contraction of bi-material or multiple layer systems.

An example of a material that expands and contracts to chemical environments is the expansion of urethane when exposed to methanol. The urethane membrane can be thermally laminated to a porous polyimide substrate. The porous substrate improves the adhesion between the two materials by interpenetration of the two materials. The porous substrate also permits diffusion of the methanol and thereby increasing the access rate of methanol to the urethane layer from all sides. This increases the responsiveness of the actuator. When this bi-material system is exposed to methanol vapor the urethane expands and the bi-material bends.

An example of a bi-material system that curls with hydrogen content is a palladium membrane coated on a porous polyimide substrate system. The palladium can expand up to 5% at 100% hydrogen content around the actuator. The porous substrate improves the adhesion between the two materials by interpenetration of the two materials. The porous substrate also permits diffusion of the hydrogen and thereby increasing the access rate of hydrogen to the palladium layer from all sides. This increases the responsiveness of the actuator.

An example of a material that expands and contracts with electrical stimulation is Nafion. When an ion current flows through Nafion water molecules are moved across by ion drag. This causes the side that receives the ions and water molecules to expand and the side that is depleted of water to contract. A bi-material structure can be made with the Nafion coupled with a material insensitive to water to acts as the structural support such as porous polyimide.

An example of a light stimulated actuation is where the light stimulates a chemical reaction, such as forming hydrogen gas from methanol with light interacting with titanium dioxide photo catalysts suspended in an electrolyte (Nada et. al.) where the hydrogen gas creates an expansion force and actuates a membrane The hydrogen can make a material such as a metal, such as a film of palladium or titanium, swell to create mechanical force or the hydrogen can be contained as pressurized gas pockets and expand a material. In this system the methanol, or other hydrocarbons such as ethanol, lactic acid are liquids dissolved in the electrolyte. The electrolyte can be a solid polymer electrolyte such as Nafion, or DAIS. The electrolyte can be surrounded by a fiberglass network or porous polymer matrix. The hydrogen gas created with the interaction with light forms bubbles in a plastic matrix that then pressurizes the material. When the light source is removed the photo catalyst gradually oxidizes the hydrogen or the hydrogen diffuses out of the matrix and relaxes the actuation.

Aperture and Valve Systems

From the basic bi-material actuation effect a system of utilizing the actuation needs to occur to form a useful device. Our first actuators open or close a cover over an aperture. We will describe this system in detail in preferred embodiments, but several other following actuation systems shall be mentioned.

Another embodiment of valves of two or more porous layers of organized or randomly positioned sparsely populated distinct pores such as an etched nuclear particle tracked membrane. Due to the randomness and sparse placement, the pores will rarely line up so most of the pores will seal against the adjacent membrane. These aperture membranes can be held together or pulled apart by the actuator, which is either laminated to the aperture membranes, or at least one of the aperture membranes is a bi-material, with the actuating membrane component being permeable to fluids or diffusion.

A new application of the laminate material actuators is to use the actuation valve response for one chemical to regulate flow of another. A material that swells with a specific chemical such as water to a hydro-gel, can be used to control the diffusion of methanol. The hydro-gel expands with water but not with alcohol in a mixture. An example of this control is in fueling fuel cells with the diffusion of methanol fuel at a desirable low concentration, from a high concentration fuel supply. When the fuel cell is operating and producing water the membrane is actuated open and increases the diffusion of methanol. When the fuel cell is idling the production of water is low causing the membrane apertures to close and reduces the diffusion delivery rate of methanol, thereby creating a self-regulating fuel delivery system that delivers methanol fuel when it is needed.

It is desirable in some applications to have membranes that change their permeability with heat and in particular, membranes that reduce their permeability as we raise the temperature such as stabilizing a fueled heat reaction. We could use Bi-material membranes or components, that when they go above a certain temperature, deform and cause the valve membranes to close and seal. This can provide a negative feedback loop to the fueling of a heat generating reaction of system; throttling the fuel delivery and power output above a certain temperature.

In some applications the actuated valves can also serve as one way valves to flow. A flap valve with a moisture swelling and a non-swelling component to create mechanical curl to achieve an opening and can also be used as a fluid valve. In flap valve designs we have coated or laminated asymmetrical flaps with a material that expands when humidified and creates a high mechanical force with that expansion. This same flap valve can act as a one-way fluid flow valve. Unique applications are in apparel where periodic body movement can create air flow pumping in shoes, socks, gloves, pants and jackets. Other applications are in buildings and in boat air vents that open passively with humidity or temperature and will permit low flow rates in either direction. But can be forced open with a blower in one direction and will seal shut against forced air or liquid flow in the reverse direction.

The bi-material actuators can be combined with piezoelectric actuation and other actuation mechanisms that can permit the actuators to be actively moved. The bi-material actuators can be pumps of fluids if the actuators are made to mechanically oscillate. Piezoelectric systems can be created with the bi-material actuators and electrodes that will allow the actuators to have electrical outputs or inputs, thus the actuators can also work as sensors with electrical outputs. These actuators can sense humidity, temperature, airflow, heat flow, vibrations, sound, and light. The bi-material actuators can form a basic component to many systems.

The laminate actuator can be combined with our pending patent U.S. Ser. No. 11/064961 “Photocatalysts, electrets, and hydrophobic surfaces used to filter and clean and disinfect and deodorize”. The actuated vems may be coated with photocatalyts, to be electrostatic or be hydrophobic to be self cleaning and disinfecting and deodorizing.

The laminate actuator can be combined with our pending catalytic heater and fuel delivery application U.S. Ser. No. 60/327,310 “Membrane Catalytic Heater” to control the diffusion or fluid flow of fuel or oxygen.

The laminate actuator can be combined with our pending U.S. provisional patent application No. 60/682,293 “Insect repellent and attractant and auto-thermostatic membrane vapor control delivery system”. The actuated vents can open to enable scents to diffuse and/or control the delivery of chemical fuels by diffusion or by fluid flow within the desired temperature range that is the active temperatures for mosquitoes.

The laminate actuator can be combined with our Fuel Cell U.S. Pat. No. 5,631,099 “Surface Replica Fuel Cell”, U.S. Pat. No. 5,759,712 Surface Replica Fuel Cell for Micro Fuel Cell Electrical Power Pack”, U.S. Pat. No. 6,326,097 B1 “Micro-Fuel Cell Power Devices”, U.S. Pat. No. 6,194,095 “Non-Bipolar Fuel Cell Stack Configuration”, U.S. Pat. No. 6,630,266 “Diffusion Fuel Ampoules for Fuel Cells” B2 U.S. Pat. No. 6,645,651 B2 “Fuel Generation with Diffusion Ampoules for Fuel Cells”. In all these patents the reactants, products, humidity, and temperature can be controlled with laminate material actuators.

These and further and other objects and features of the invention are apparent in the disclosure, which includes the above and ongoing written specification, with the claims and the drawings.

### BRIEF DESCRIPTION OF THE DRAWINGS

FIG. 1A shows a bi-material actuated flap valve (thermal, humidity, or chemical actuated) cross-section view.

FIG. 1B shows a single flap valve oblique view.

FIG. 2A shows the humidity and temperature actuating flap valves shown open cross-sectional view.

FIG. 2B shows flap valve bottom view.

FIG. 3A shows opposing temperature, humidity, and piezoelectric actuators'cross-sectional view.

FIG. 3B shows opposing actuation temperature and humidity and electrode sensitivity underside view.

FIG. 4A shows piezoelectric and thermal or humidity actuation.

FIG. 4B shows piezoelectric and thermal or humidity actuation bottom view.

FIG. 5A shows a side view of stacked actuated flap arrays actuated open.

FIG. 5B shows a side view of stacked actuated flap arrays actuated closed.

FIG. 6A shows a cross-sectional view of an actuated vent membrane and aperture membranes.

FIG. 6B shows non-actuated membrane in the closed mode cross-sectional view.

FIG. 7 shows offset patterns of apertures of the fixed apertures of the actuated aperture membrane.

FIG. 8A shows actuated membrane with slit patterns and actuating elements on either sides of membrane.

FIG. 8B shows actuated membrane with slit patterns top view.

FIG. 9 shows hexagonal flaps and hexagonal lattice.

FIG. 10 shows square flaps with square lattice.

FIG. 11 shows triangular flaps with square lattice.

FIG. 12 shows triangular flaps with hexagonal lattice.

FIG. 13 shows triangular flaps with square lattice.

FIG. 14A shows opened actuated actuator flap with encapsulated swelling material cross-sectional view.

FIG. 14B shows closed actuated flap with encapsulated swelling material cross-sectional view.

FIG. 15 shows heel portion of shoe sole cross-section view.

FIG. 16 shows sole assembly exploded view.

FIG. 17 shows underside view of shoe sole.

FIG. 19A shows transverse valve opening actuation with two (push-pull) actuators.

FIG. 19B shows transverse actuated membrane with flow blocked.

FIG. 20A shows stacked bi-material actuators and valve-closed position.

FIG. 20B shows stacked bi-material actuators and valve open position.

FIG. 21 shows bi-material coil with airflow perforation cross-sectional view.

FIG. 22A shows bi-material actuation fabric.

FIG. 22B shows cylinder extruded bi-material fiber cross-sectional and side view.

FIG. 22C shows rectangular strip of bi-material fiber.

FIG. 22D shows twist wrap-around coating fiber.

FIG. 22E shows “S” coating fiber un-actuated cross-section and side view.

FIG. 22F shows cold sensitized coated “S” fiber isometric view.

FIG. 23A shows contracted spring helix with twist coated fiber side view.

FIG. 23B shows an expanded spring helix with twist coated fiber.

FIG. 24A shows actuating X-slit with black material underneath, light (or heat) sensitive actuator (Cold Curled), side and cross-sectioned view.

FIG. 24B shows heated/warm light sensitive bi-material actuator (Warm enough that light is reflected while flaps lay flat), cross-section with isometric view.

FIG. 25 shows active actuator shoe side view.

FIG. 26A shows directionally reinforced (coated) bi-material actuator.

FIG. 26B shows groove directionally reinforced bi-material actuator.

FIG. 27 shows pinwheel apertures with sharp edges.

FIG. 28 shows pinwheel aperture with curves.

FIG. 29 shows three-dimensional plot of a mathematical description of an elastic polymorphic surface membrane.

FIG. 30A shows cross-sectional view of the un-actuated bi-material polymorphic surface.

FIG. 30B shows cross-sectional view of the actuated bi-material polymorphic surface.

FIG. 30C shows underside view of the actuated bi-material polymorphic surface.

FIG. 31A Actuators on fiber in low stress, actuator down-mode.

FIG. 31B Actuators on fiber in high stress, actuator up-mode.

### DETAILED DESCRIPTION OF THE PREFERRED EMBODIMENTS

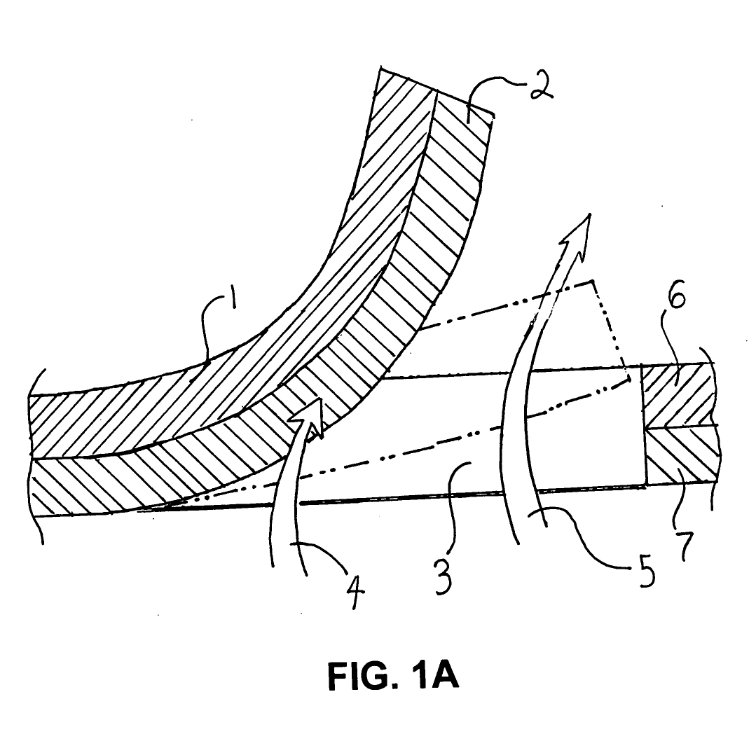

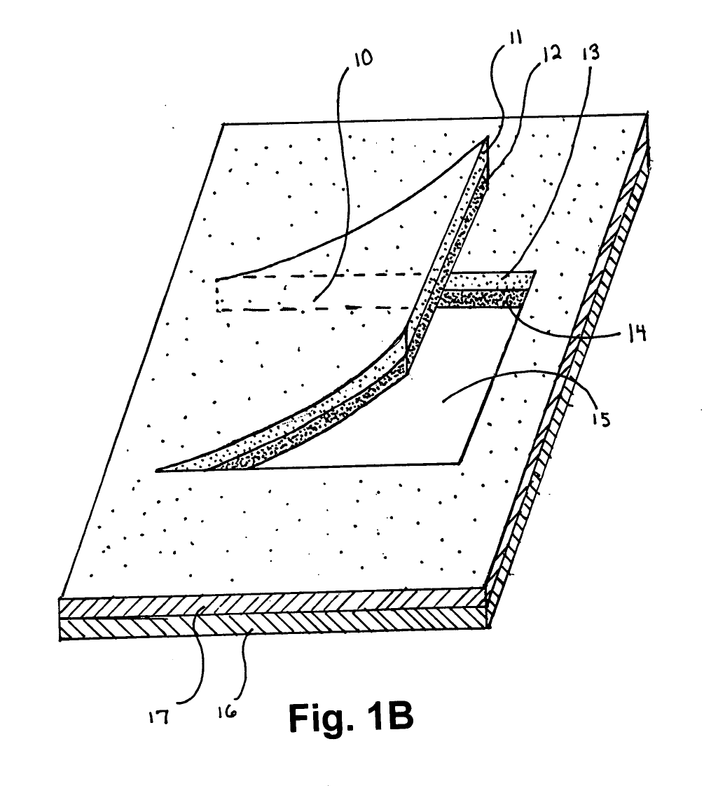

FIG. 1A shows a bi-material actuated flap valve (thermal, humidity, or chemical actuated) cross-section view.
1. Non-expanding substrate material
2. Expansion material bonded to substrate material
3. Opening aperture created by the flap actuation
4. Humidity, heat, or chemical interaction to expand material
5. Air flow or diffusion through open flap
6. Non-expanding substrate
7. Expansion material

FIG. 1B shows a single flap valve oblique view.
10. Flap valve
11. Low expansion coefficient material
12. High expansion coefficient material
13. Low expansion coefficient material
14. High expansion coefficient material
15. Open aperture
16. High expansion coefficient material
17. Low expansion coefficient material

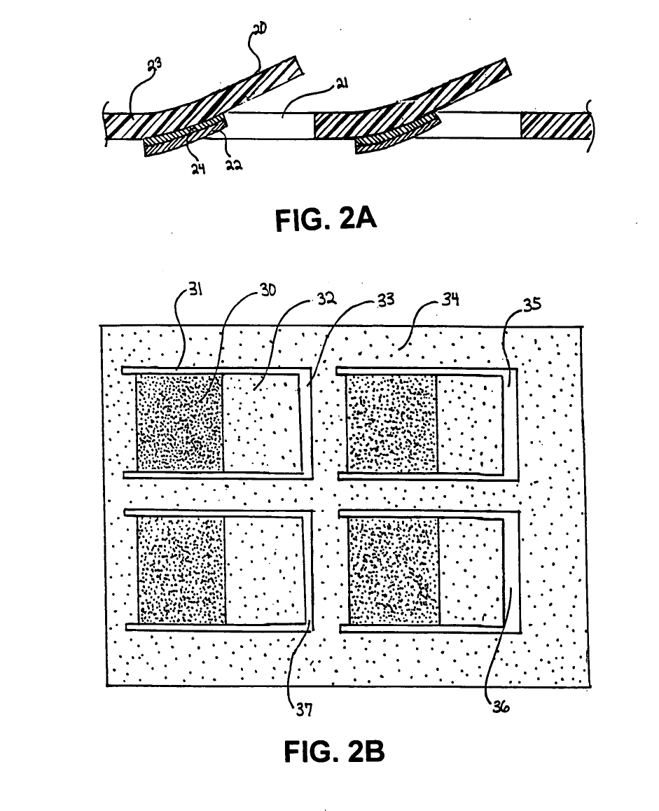

FIG. 2A shows the humidity and temperature actuating flap valves shown open cross-sectional view.
20. Flap valve
21. Aperture opened
22. High humidity coefficient of expansion material
23. Low coefficient of expansion material and substrate
24. Temperature sensitive high expansion coefficient coating
25. Humidity sensitive high expansion coefficient coating

FIG. 2B shows flap valve bottom view.
30. High coefficient of expansion material coating
31. Cut out aperture
32. Low coefficient of expansion material flap
33. Channel when aperture is open
34. Low coefficient of expansion material
35. Channel when aperture open
36. Channel when aperture open
37. Channel when aperture open

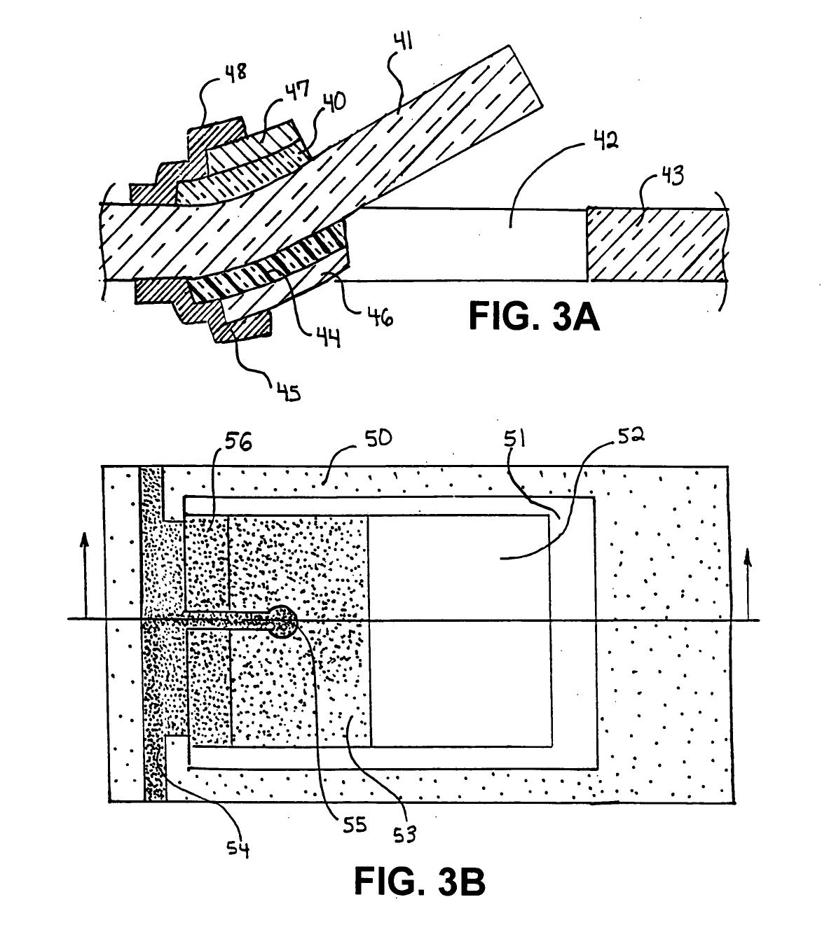

FIG. 3A shows opposing temperature, humidity, and piezoelectric actuators'cross-sectional view.
40. High expansion temperature coefficient material
41. Low coefficient of expansion substrate piezoelectric
42. Open aperture
43. Substrate material
44. High expansion temperature coefficient material
45. Electrode
46. High humidity expansion coefficient material
47. High humidity expansion coefficient material
48. Electrode

FIG. 3B shows opposing actuation temperature and humidity and electrode sensitivity underside view.
50. Substrate material
51. Cutout region of flap
52. Flap
53. High humidity expansion coefficient material
54. Electrical circuit patterns
55. Electrical contact to piezoelectric or electrochemical cell
56. High expansion temperature coefficient material

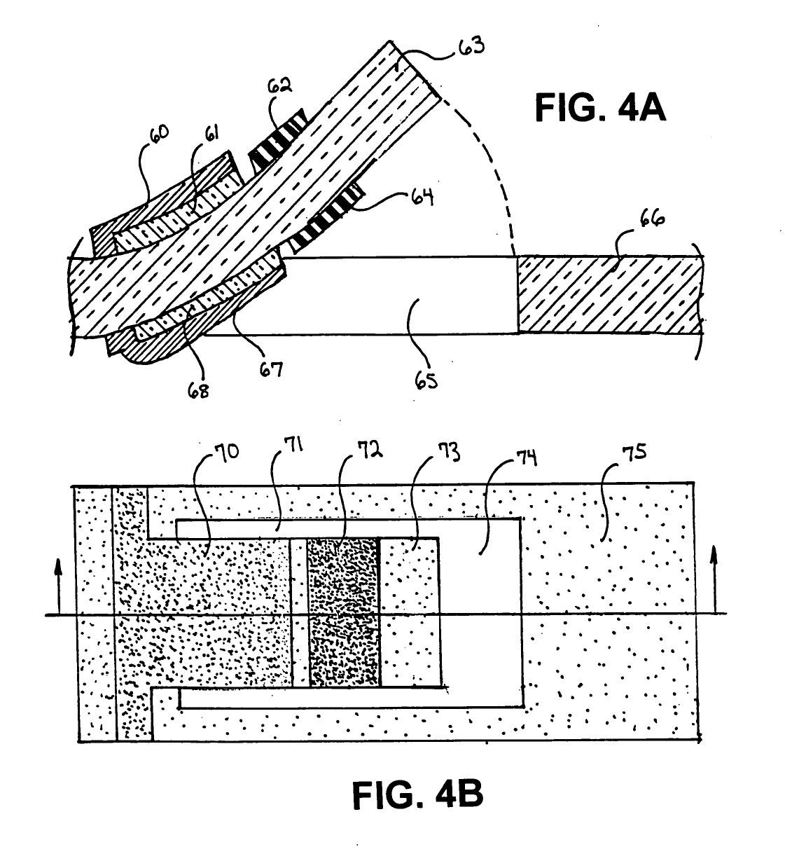

FIG. 4A shows piezoelectric and thermal or humidity actuation.
60. Electrode
61. Piezoelectric material
62. Humidity or temperature low expansion material
63. Substrate material
64. Humidity or temperature sensitive material
65. Opened aperture
66. Substrate material
67. Electrode
68. Piezoelectric material

FIG. 4B shows piezoelectric and thermal or humidity actuation bottom view.
70. Electrode
71. Clearance slit between flap and substrate material
72. Humidity or temperature non-sensitive material
73. Flap substrate material
74. Open aperture
75. Substrate material

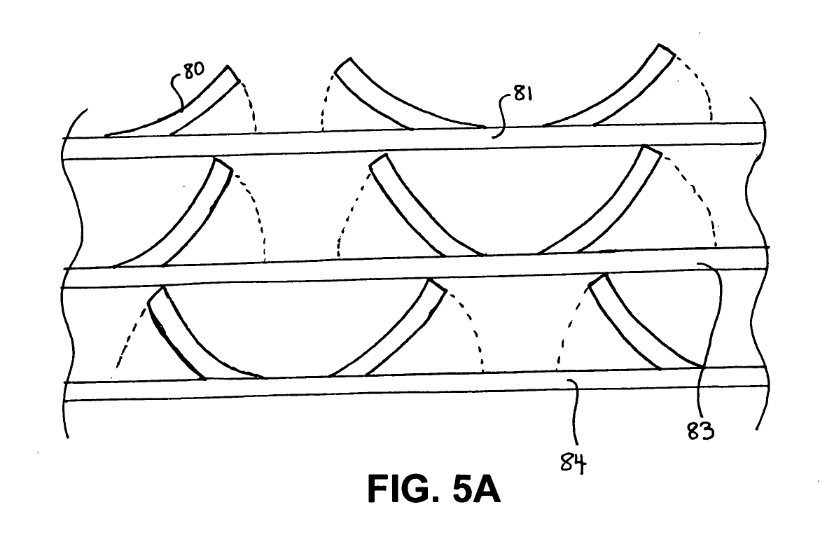

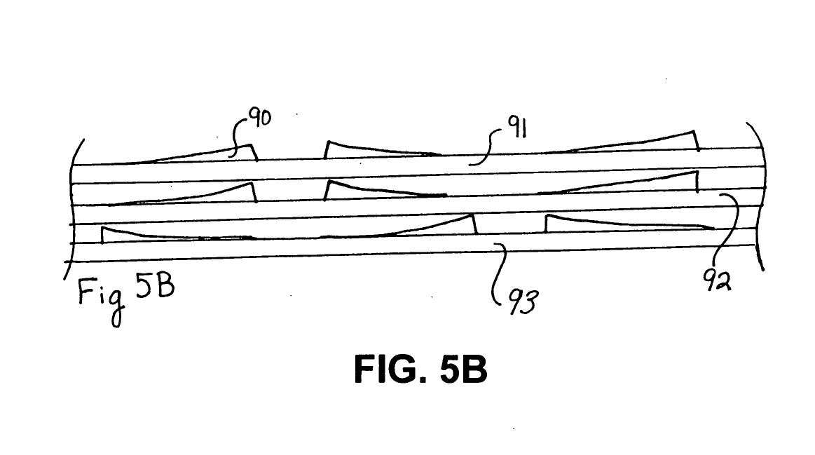

FIG. 5A shows a side view of stacked actuated flap arrays actuated open.
80. Actuated flap
81. Substrate frame
83. Second layer of actuated flaps and frame sheet
84. Third sheet of actuated flaps and frames

FIG. 5B shows a side view of stacked actuated flap arrays actuated closed.
90. Closed down actuated flap
91. Frame sheet
92. Second sheet of flaps and apertures
93. Third sheet of flaps and apertures

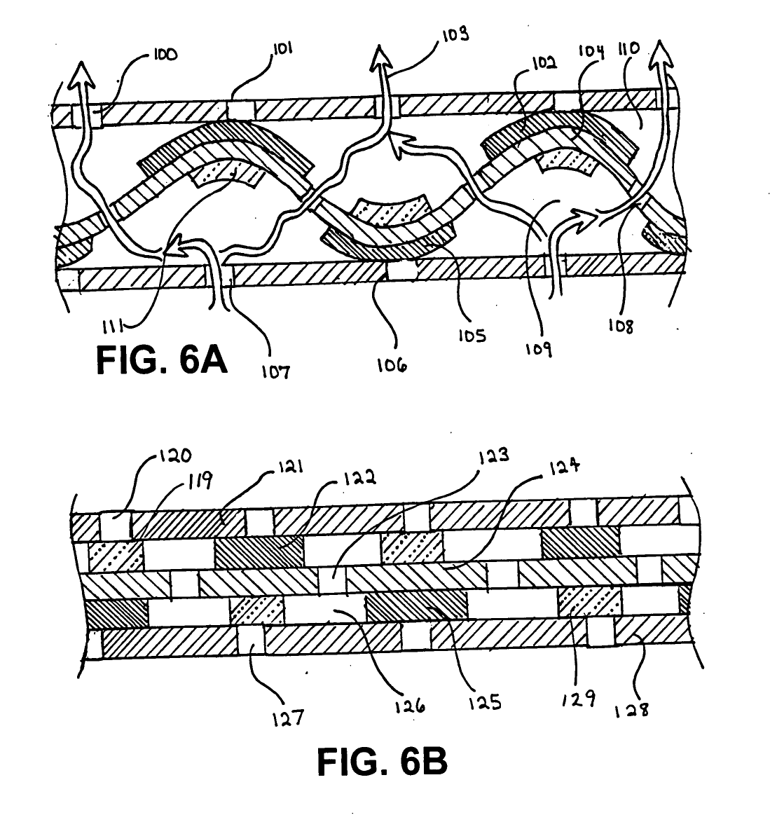

FIG. 6A shows actuated vent membrane and aperture membranes.

Cross-sectional View

100. Fixed apertures
101. Fixed aperture membrane
102. Actuating element (expanded due to temperature or humidity)
103. Diffusion or flow though apertures
104. Actuation membrane substrate
105. Actuation element on opposite side (expands due to humidity or temperature)
106. Second fixed aperture membrane
107. Apertures in second fixed aperture membrane
108. Actuated membrane apertures
109. The inner space gap between membranes
110. The inner space gap between membranes
111. Sealer made of flexible material

FIG. 6B shows non-actuated membrane in the closed mode cross-sectional view.
119. Sealing coating
120. Fixed apertures
121. Fixed aperture membrane
122. Actuation element (contracted)
123. Actuated membrane aperture
124. Actuation membrane substrate
125. Second side actuation element
126. Second gas gap between membranes
127. Aperture in second fixed membrane
128. Fixed membrane apertures
129. Sealing coating

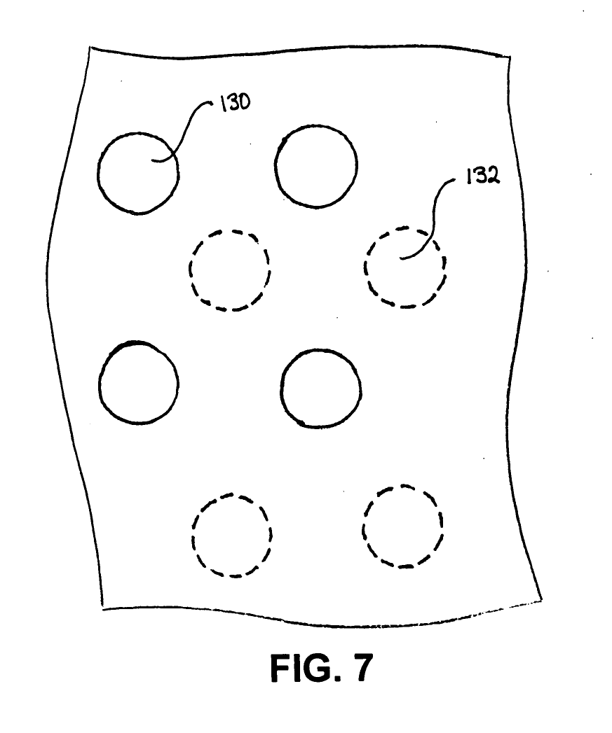

FIG. 7 shows offset patterns of apertures of the fixed apertures of the actuated aperture membrane.
130. Fixed aperture on top
132. Aperture in a second membrane beneath the fixed apertures

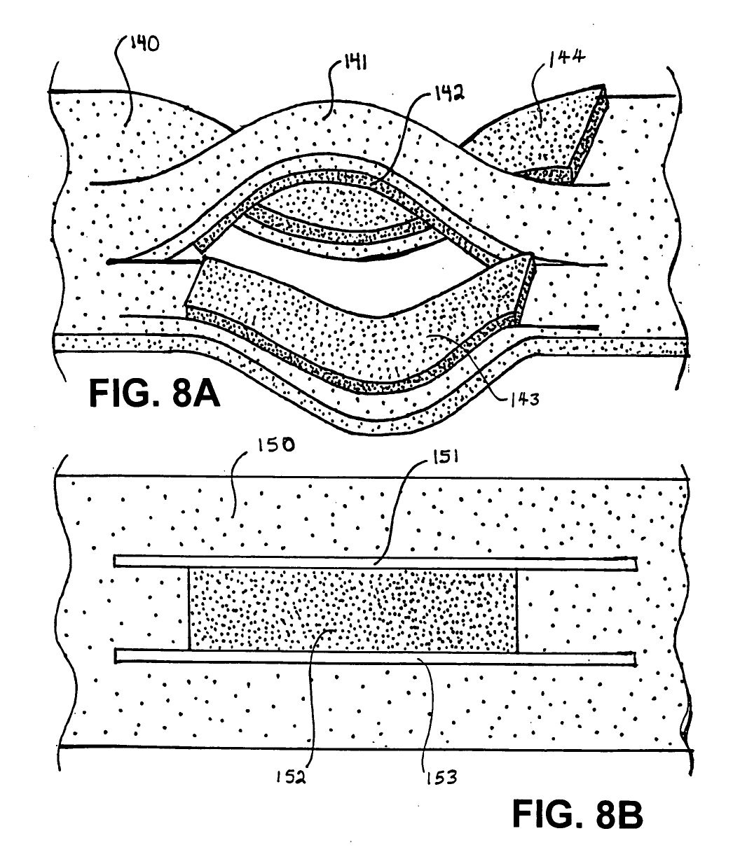

FIG. 8A shows actuated membrane with slit patterns and actuating elements on either sides of membrane.
140. Substrate material (flexible)
141. Substrate material
142. Actuating element
143. Actuating element
144. Actuating element

FIG. 8B shows actuated membrane with slit patterns top view.
150. Substrate material
151. Slot or cut in the substrate material
152. Actuating element or coating
153. Cut in substrate

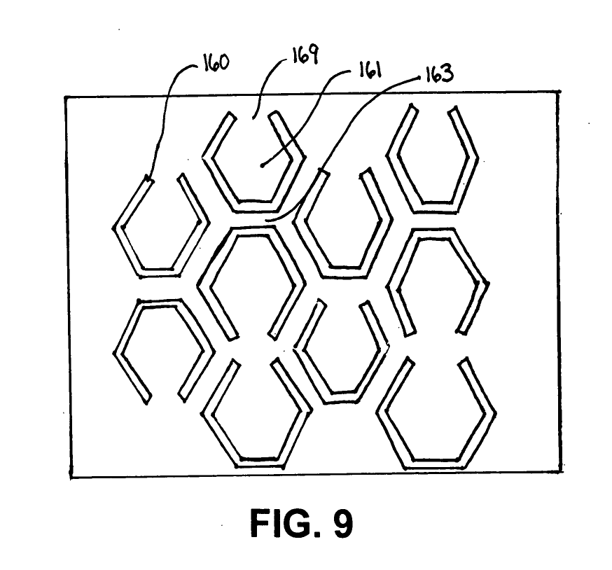

FIG. 9 shows hexagonal flaps and hexagonal lattice.
160. Slit
161. Flap
163. Hexagonal lattice
169. Bend point

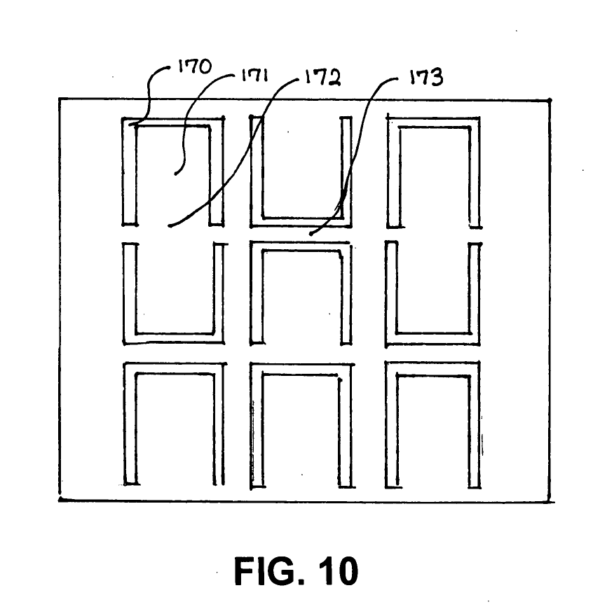

FIG. 10 shows square flaps with square lattice.
170. Slit
171. Flap
172. Bend point
173. Square lattice

FIG. 11 shows triangular flaps with square lattice.
180. Slit
181. Triangular flap
182. Bend point
183. Square lattice

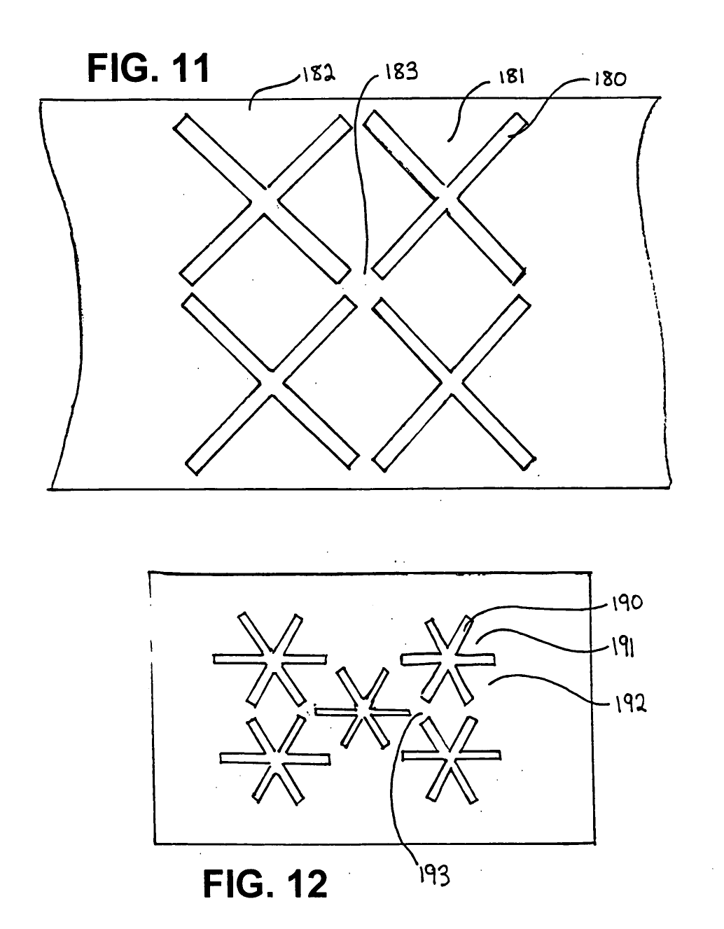

FIG. 12 shows triangular flaps with hexagonal lattice.
190. Slit
191. Triangular flap
192. Bend point
193. Hexagonal lattice

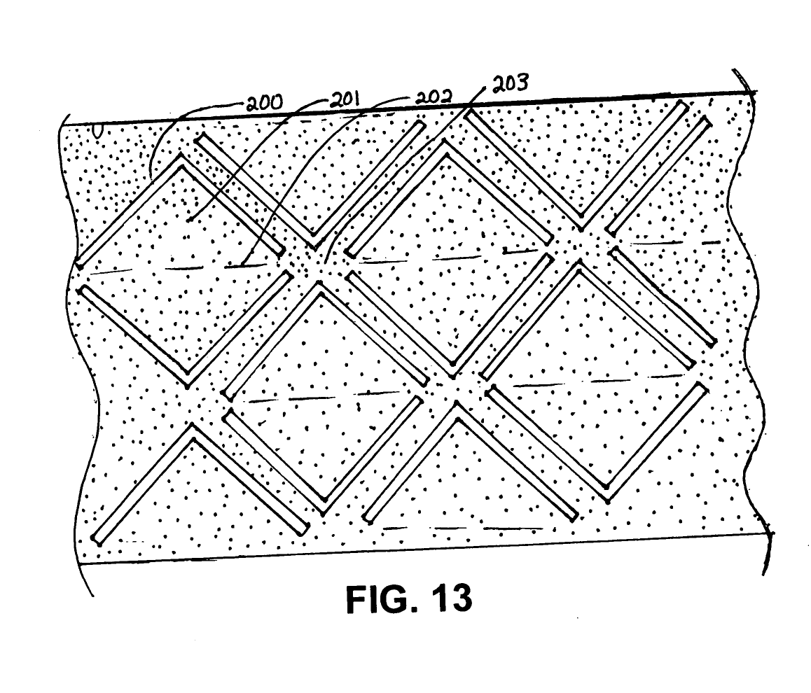

FIG. 13 shows triangular flaps with square lattice.
200. Slit
201. Flap
202. Bend line
203. Square lattice

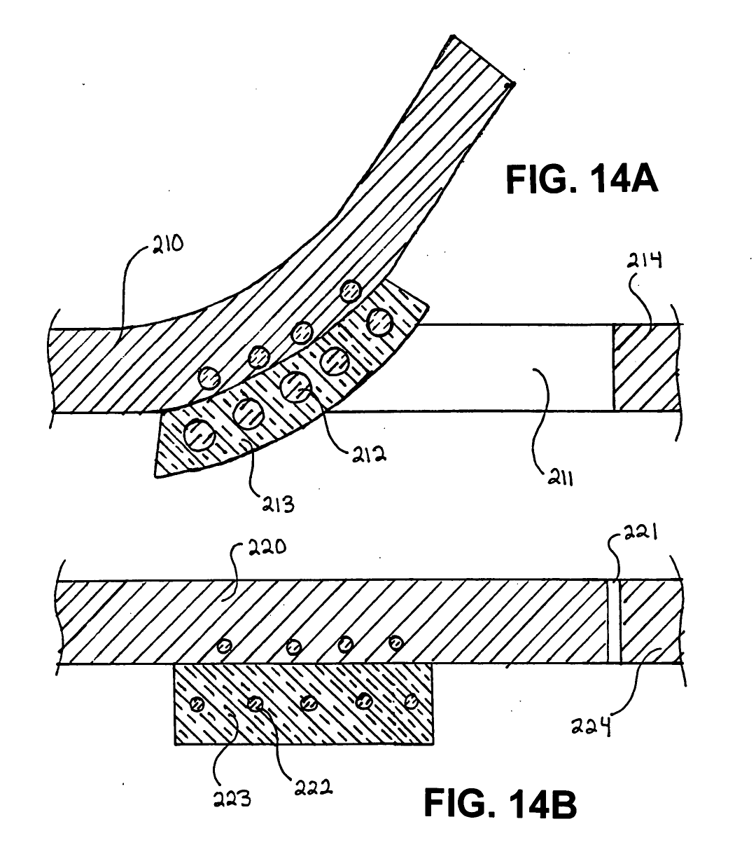

FIG. 14A shows opened actuated actuator flap with encapsulated swelling material cross-sectional view.
210. Substrate material flap (curled)
211. Aperture cut in
212. Expanding material expanded
213. Permeable encapsulate of expanding material
214. Substrate material frame

FIG. 14B shows closed actuated flap with encapsulated swelling material cross-sectional view.
220. Substrate material contracted
221. Gap between flap and substrate
222. Contracted material encapsulated
223. Permeable encapsulate of expanding material
224. Substrate material frame

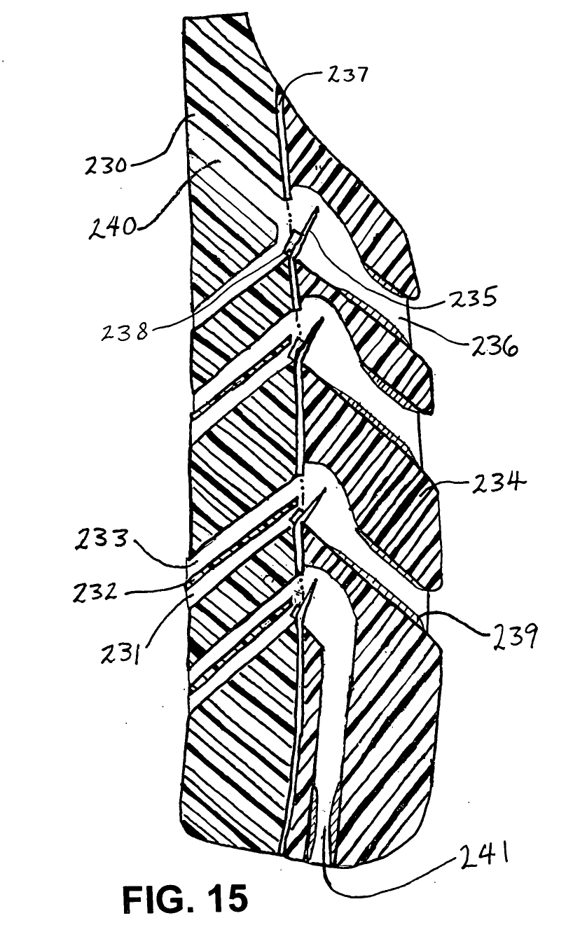

FIG. 15 shows heel portion of shoe sole cross-section view.
230. Upper sole piece
231. Formed air channels in upper sole (tilted)
232. Formed air channels in upper sole (tilted)
233. Parallel air channels in upper sole (tilted)
234. Lower sole tread
235. Actuating flap
236. Air-flow channel on lower sole
237. Actuating flap substrate and frame
238. Actuating material on flap
239. Photo catalytic and hydrophilic coating
240. Lateral flow channels in upper sole
241. Lateral flow channels in tread sole

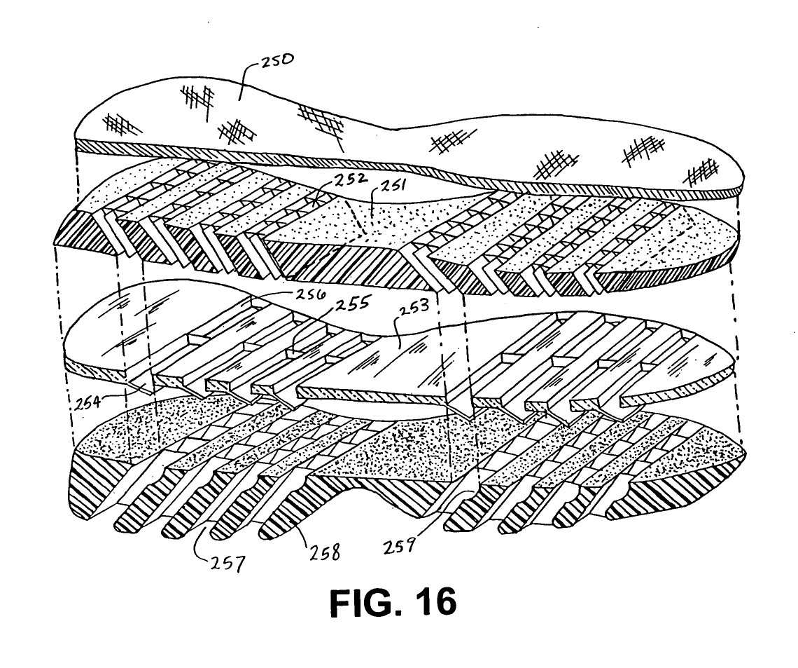

FIG. 16 shows sole assembly exploded view.
250. The cloth inner wicking upper sole
251. Upper sole material
252. Tilted channels of the upper sole
253. Inner flap substrate
254. Flaps
255. Rib material of flap frame
256. Slots cut in flap material
257. Air channels in lower substrate
258. Lower sole material
259. Flap cavities

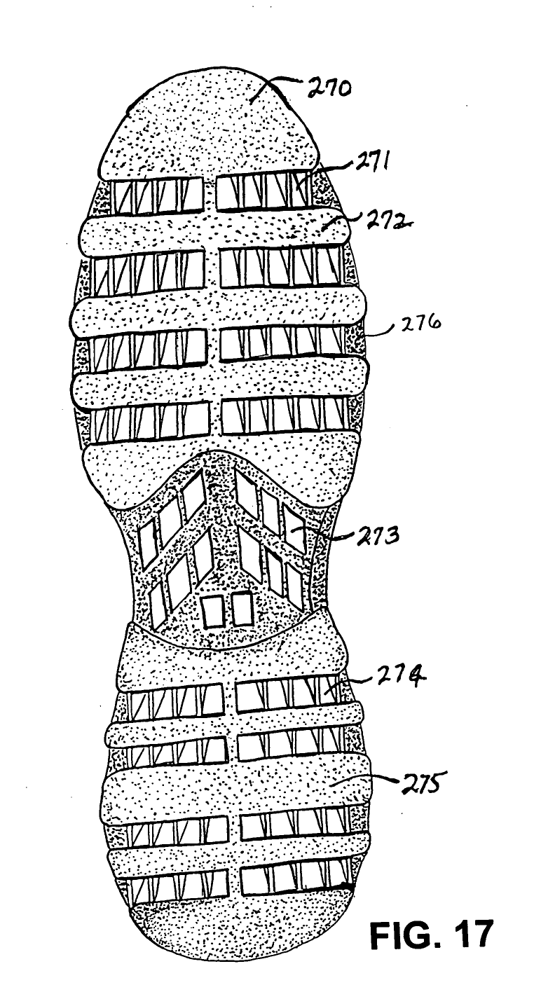

FIG. 17 shows underside view of shoe sole.
270. Toe end sole of shoe
271. Forward tilted air channels
272. Ground contact tread
273. Instep vents tilted
274. Tilted air channels in heel of sole
275. Ground contact tread in heel area of sole
276. Side flow channels

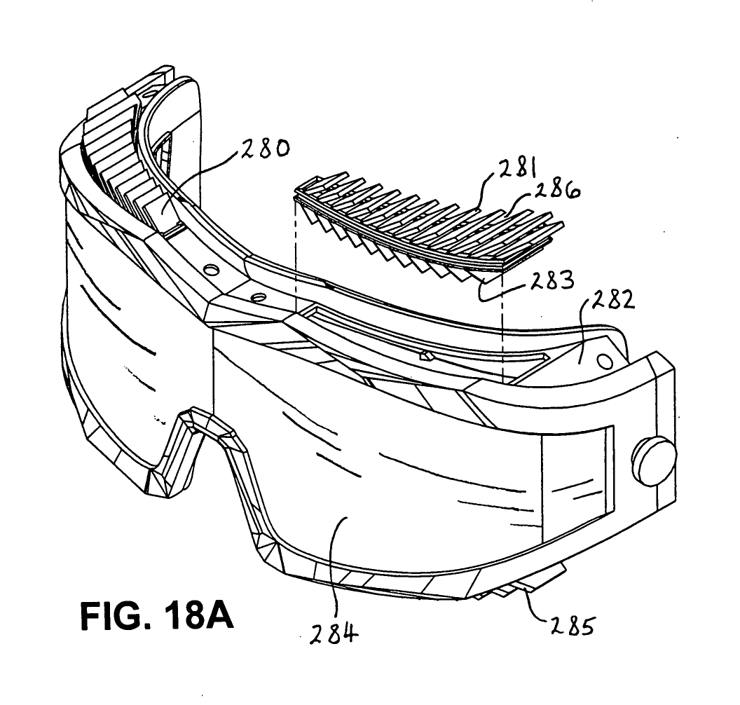

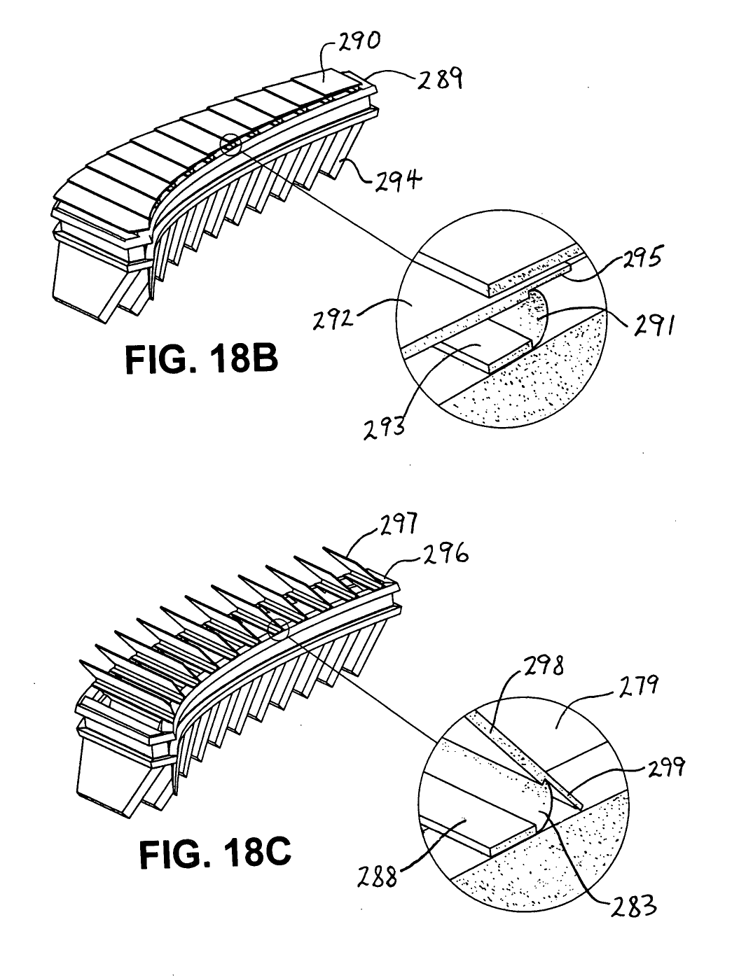

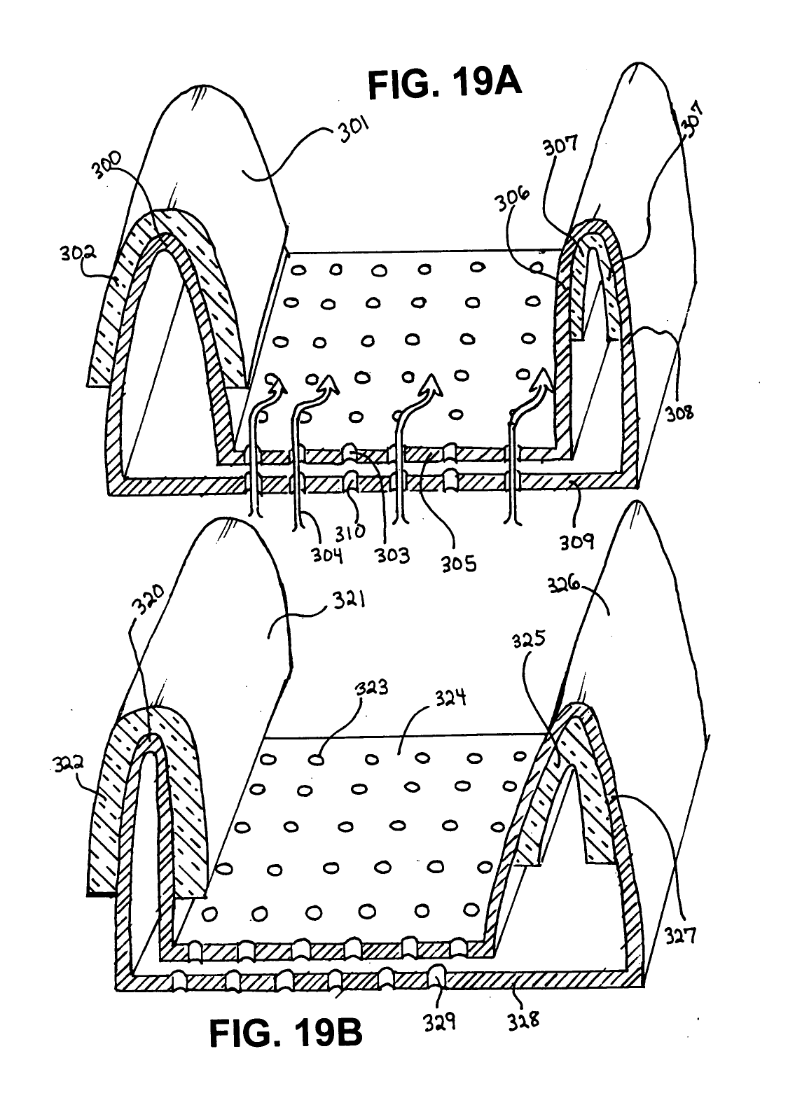

FIG. 19A shows transverse valve opening actuation with two (push-pull) actuators.

Cross-sectional View

300. Substrate material
301. Actuator component
302. Second actuator component
303. Aperture aligned to material aperture
304. Air flow channel
305. Substrate
306. Substrate material actuator
307. Inner actuator material
308. Substrate of bend
309. Substrate of aperture
310. Matching aperture

FIG. 19B shows transverse actuated membrane with flow blocked.
320. The bend substrate
321. Actuating material on outside
322. Actuating material on outside
323. Apertures
324. Aperture frame substrate
325. Inner actuator
326. Fold
327. Outer bend substrate
328. Aperture substrate
329. Non-aligned aperture

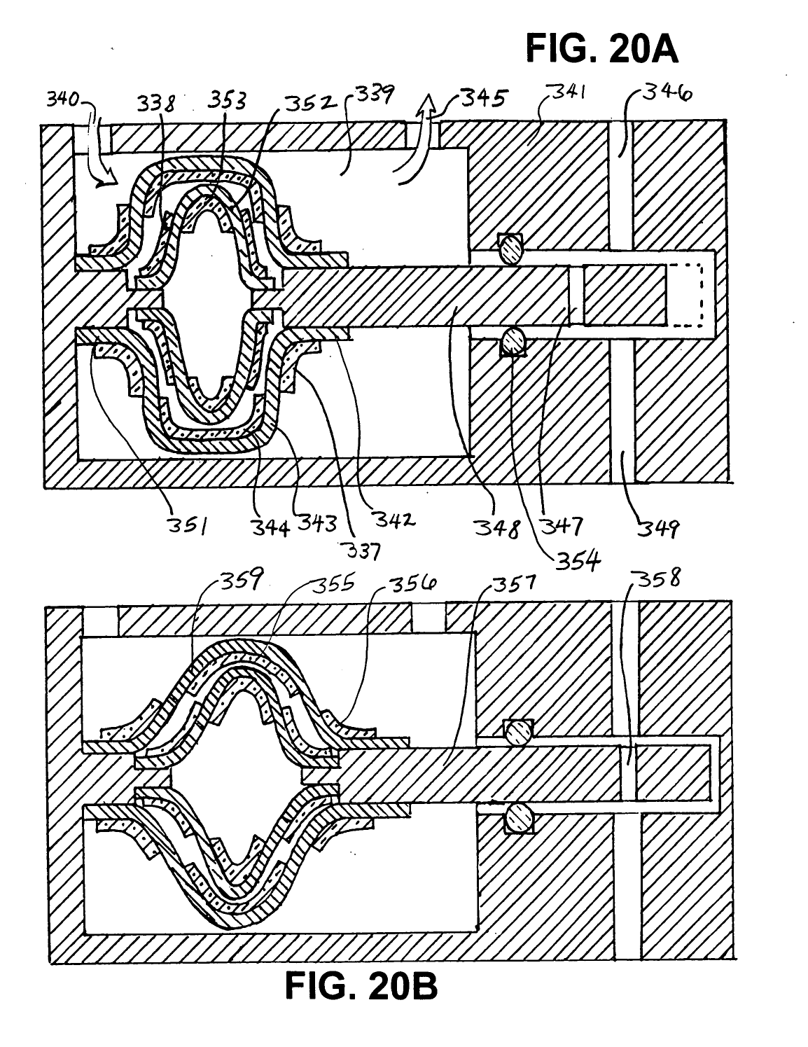

FIG. 20A shows stacked bi-material actuators and valve-closed position.
337. Actuation coating
338. Alternating actuation coating.
339. Actuation chamber
340. Fluid to be sensed flow
341. Housing
342. Attachment of membranes to shaft
343. Membrane substrates
344. Actuator material
345. Fluid exit flow to be sensed
346. Fluid Channel to be controlled
347. Bored slide rod
348. Side rod
349. Fluid outlet channel controlled by valve
351. Attachment of membranes to housing
352. Substrate membrane
353. Actuating material
354. O-ring seal

FIG. 20B shows stacked bi-material actuators and valve open position.
355. Actuating material coating
356. Actuating material coating
357. Slide rod
358. Bored slide rod
359. Bi-material substrate

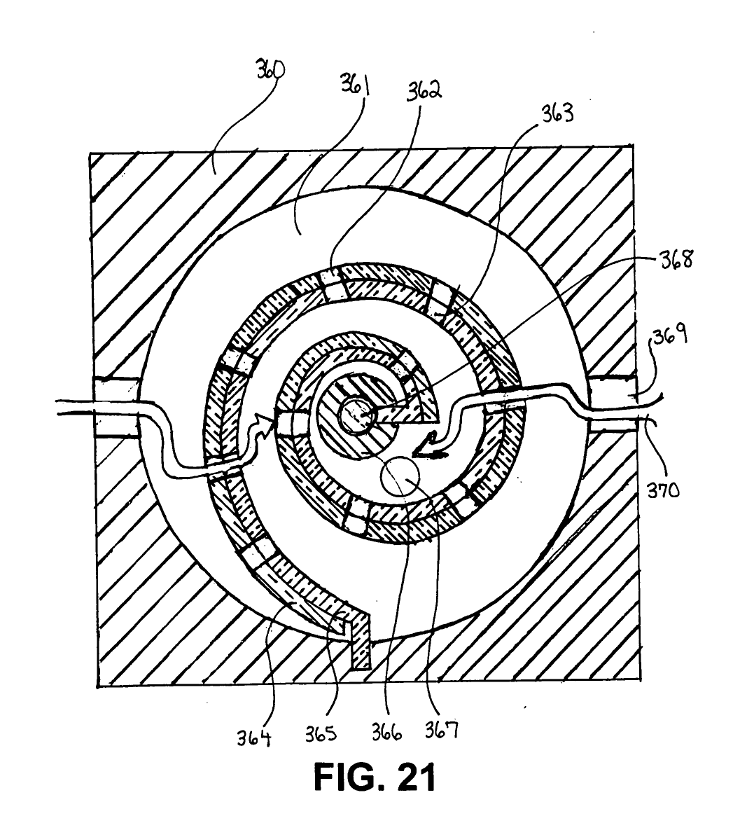

FIG. 21 shows bi-material coil with airflow perforation cross-sectional view.
360. Housing or case
361. Cavity in casing
362. Perforation in high expansion material (Humidity, temperature, chemical, or light sensitive options)
363. Perforation in low coefficient of expansion material
364. High coefficient of expansion material (Humidity, temperature, chemical, or light sensitive options)
365. Low coefficient of expansion material
366. Rotor sleeve
367. Air flow port
368. Pivot, rotational shaft
369. Air channel
370. Air flow (with humidity or moisture or heat or chemical concentration)

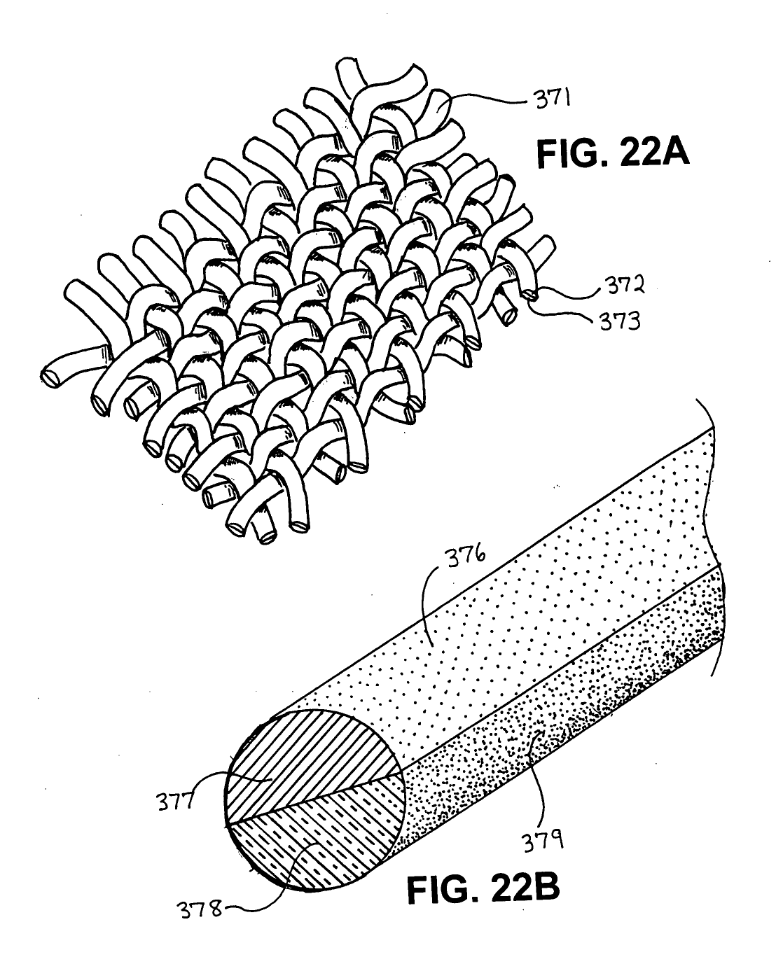

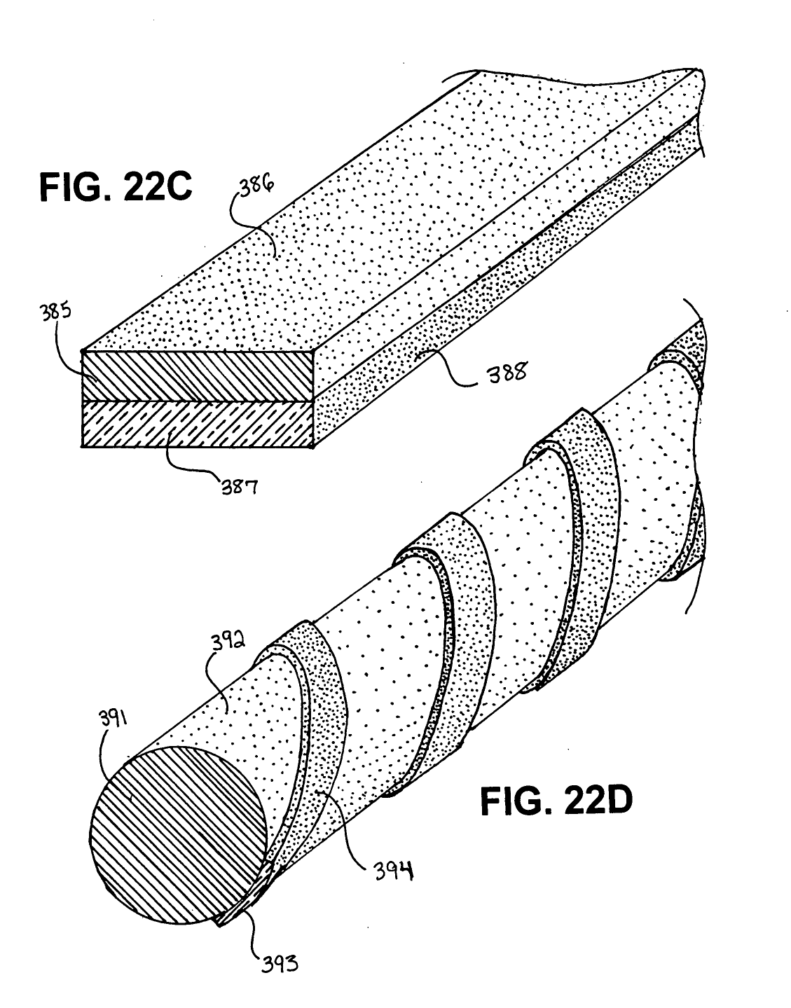

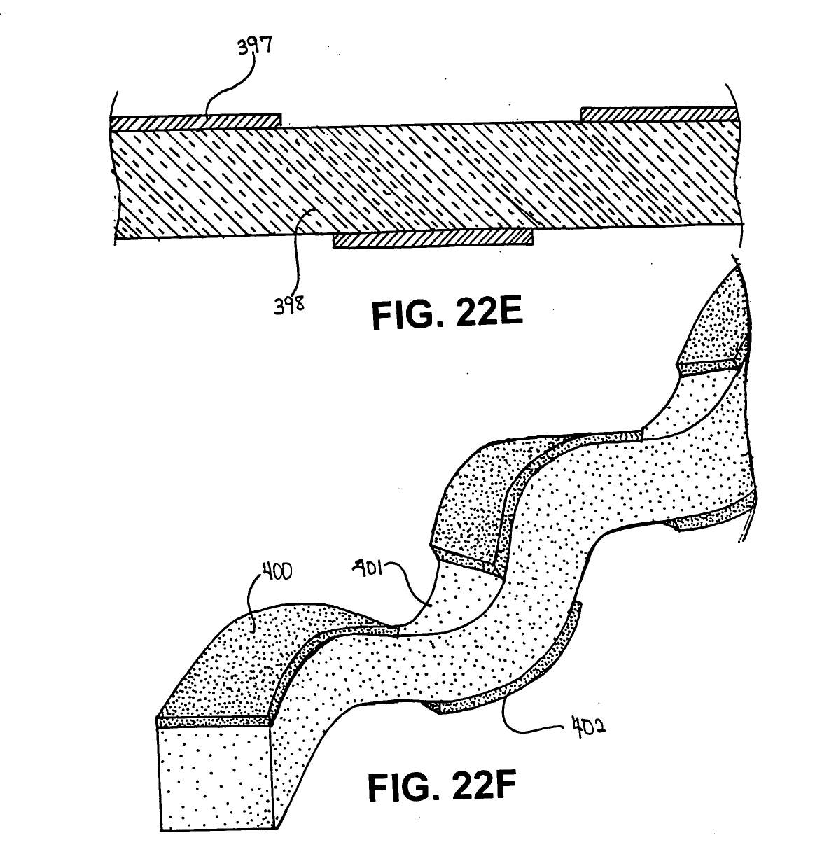

FIG. 22A shows bi-material actuation fabric.
371. Bi-material fiber
372. High coefficient of expansion material (Temperature, chemical, humidity sensitive)
373. Low coefficient of expansion material

FIG. 22B shows cylinder extruded bi-material fiber cross-sectional and side view.
376. Surface of low coefficient of expansion
377. Low coefficient of expansion material (could be metal)
378.High expansion material, may be plastic or rubber (temperature, chemical, or humidity sensitive)
379. Surface of the high coefficient of expansion material

FIG. 22C shows rectangular strip of bi-material fiber.
385. Low coefficient of expansion material
386. Surface of low coefficient of expansion material
387. Temperature, chemical, or humidity sensitive high coefficient of expansion material
388. Surface of high coefficient of expansion material

FIG. 22D shows twist wrap-around coating fiber.
391. Low coefficient of expansion material
392. Surface of low coefficient of expansion material
393. High coefficient of expansion coating (Temperature, chemical, and humidity sensitive)
394. Surface of high coefficient expansion coating

FIG. 22E shows “S” coating fiber un-actuated cross-section and side view.
397. High coefficient of expansion material coating
398. Flexible, low-coefficient material

FIG. 22F shows cold sensitized coated “S” fiber isometric view.
400. High expansion coefficient material coating
401. Low expansion coefficient material, flexible
402. High coefficient of expansion material coating

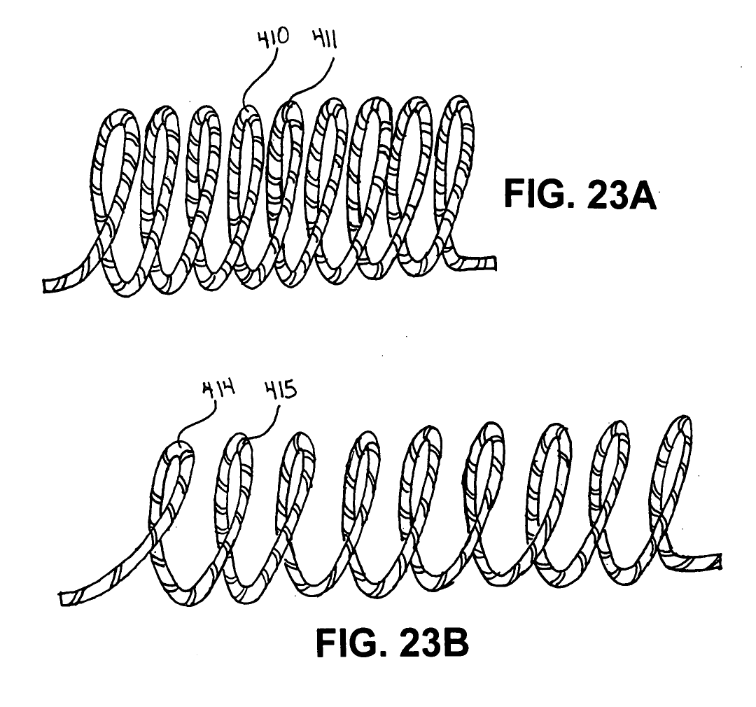

FIG. 23A shows contracted spring helix with twist coated fiber side view.
410. Low expansion coefficient material
411. High expansion coefficient material (temperature, humidity, or chemical sensitive)

FIG. 23B shows an expanded spring helix with twist coated fiber.
414. Low expansion coefficient material
415. High coefficient of expansion material (temperature, chemical, or humidity sensitive)

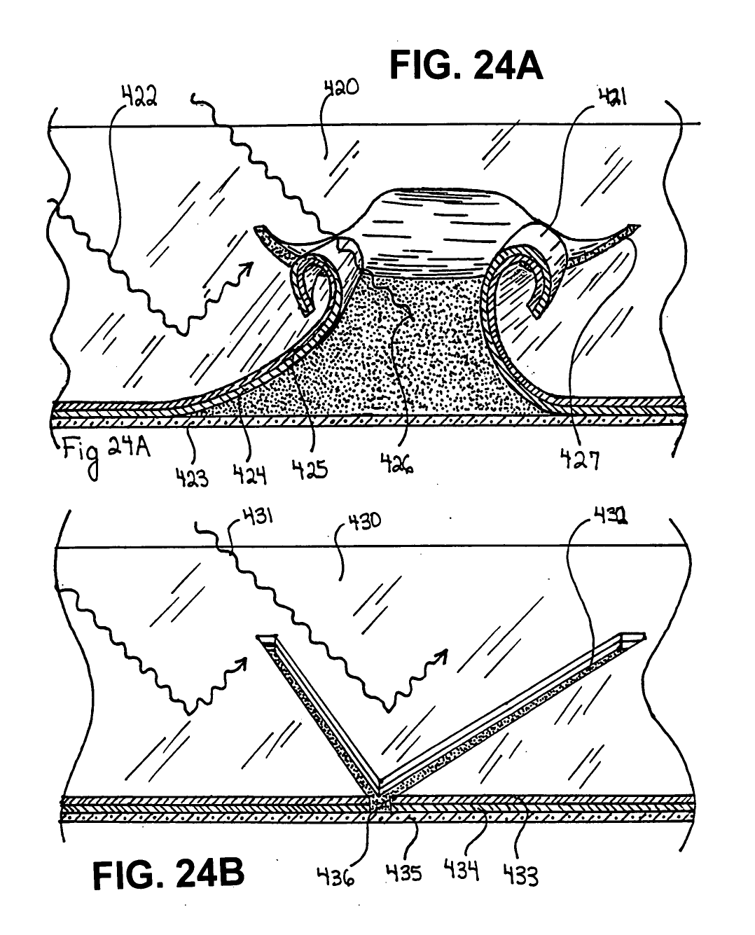

FIG. 24A shows actuating X-slit with black material underneath, light (or heat) sensitive actuator (Cold Curled), side and cross-sectioned view.
420. Reflective surface of top layer of bi-material, the high coefficient of expansion material
421. Curled or actuated flap surface of the low coefficient of expansion material
422. Light being reflected
423. Black or light absorbent material
424. Low coefficient or expansion material layer
425. High coefficient of expansion material
426. Light or heat absorbed into the surface of the black material
427. Slit/cut in the bi-material, creating flap

FIG. 24B shows heated/warm light sensitive bi-material actuator (Warm enough that light is reflected while flaps lay flat), cross-section with isometric view.
430. Reflective surface of high expansion coefficient material layer
431. Reflected light
432. Slit/cut in the bi-material
433. High coefficient expansion material
434. Low coefficient of expansion material
435. Light absorbent material
436. Surface of light absorbent material

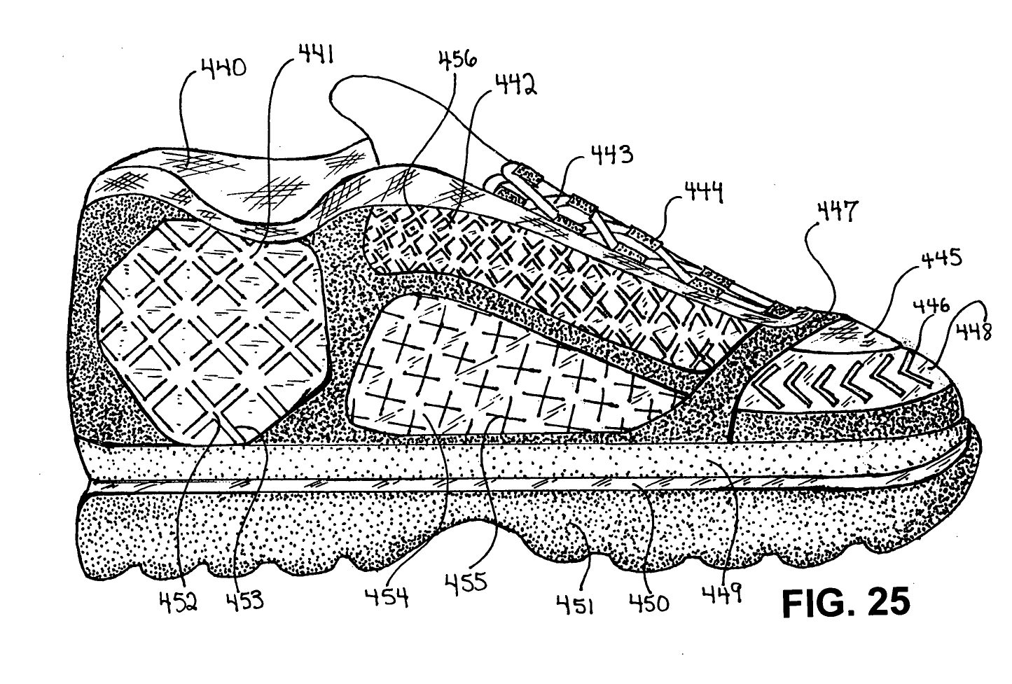

FIG. 25 shows active actuator shoe side view.
440. Fabric with wicking and breathable properties
441. Actuator sheet, shown as reflective, X-lattice pattern
442. Actuator material sheet, Coated/bi-material X-lattice pattern
443. Shoe lace
444. Shoe lace loop or islet
445. Fabric
446. Cut in the actuator material, for triangular apertures
447. Shoe material, strong and semi-flexible
448. Actuator material sheet triangular pattern (may be reflective as shown)
449. Upper sole material
450. Inner flap substrate
451. Lower sole material
452. Actuator lattice portion of actuator material
453. Slit in actuator material
454. Actuator material sheet with X-slit pattern
455. X-slit
456. V-slit

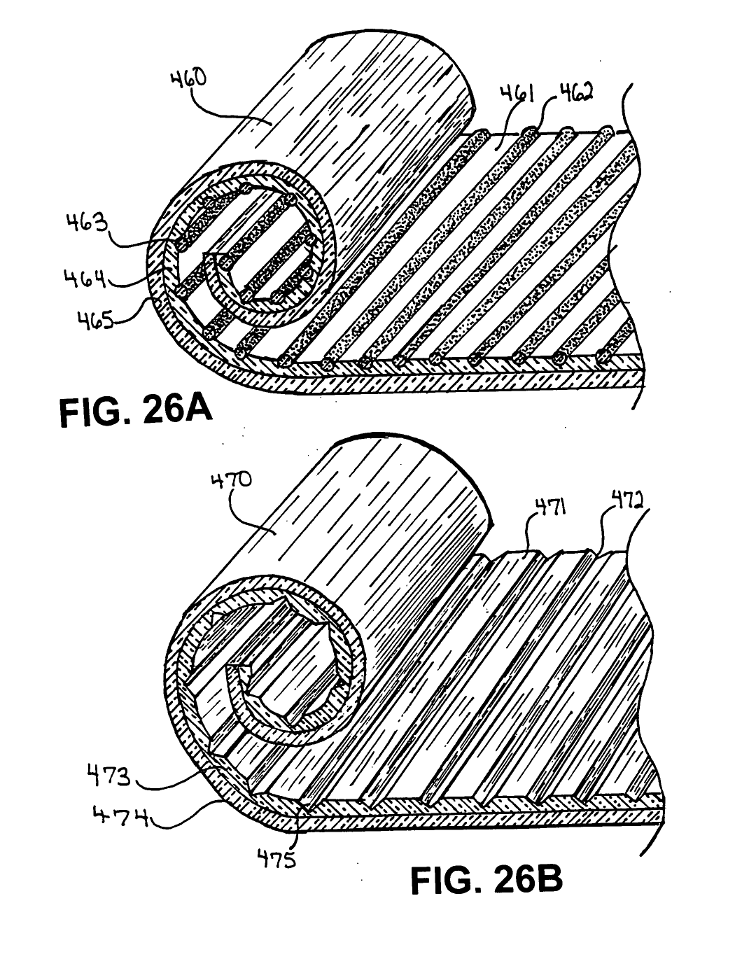

FIG. 26A shows directionally reinforced (coated) bi-material actuator.
460. High coefficient of expansion material, surface
461. Low coefficient of expansion material surface
462. Coating or strip preventing bending perpendicular to strip
463. Coating material
464. Low coefficient of expansion material (chemical, temperature, humidity, or light sensitive material)
465. High coefficient of expansion material

FIG. 26B shows groove directionally reinforced bi-material actuator.
470. Surface of the high confident of expansion (Temperature, light, chemical, or humidity sensitive)
471. Surface of the low coefficient of expansion material
472. Groove cut into the low expansion material
473. Low coefficient of expansion material
474. High coefficient of expansion material (temperature, chemical, humidity, or light sensitive)
475. Groove cut in Low expansion material

FIG. 27 shows pinwheel apertures with sharp edges.
480. Bi-material sheet
481. Slit/cut in the bi-material sheet
482. Area where the flap will bend
483. Actuator flap

FIG. 28 shows pinwheel aperture with curves.
486. Slit/cut in bi-material sheet
487. Actuator flap
488. Bi-material sheet

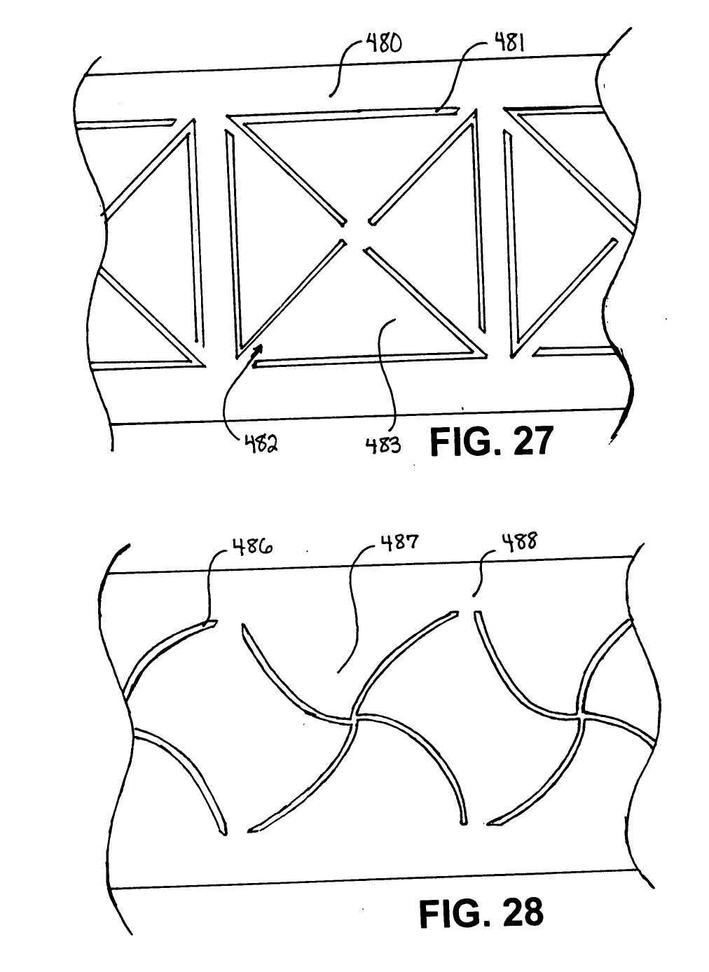

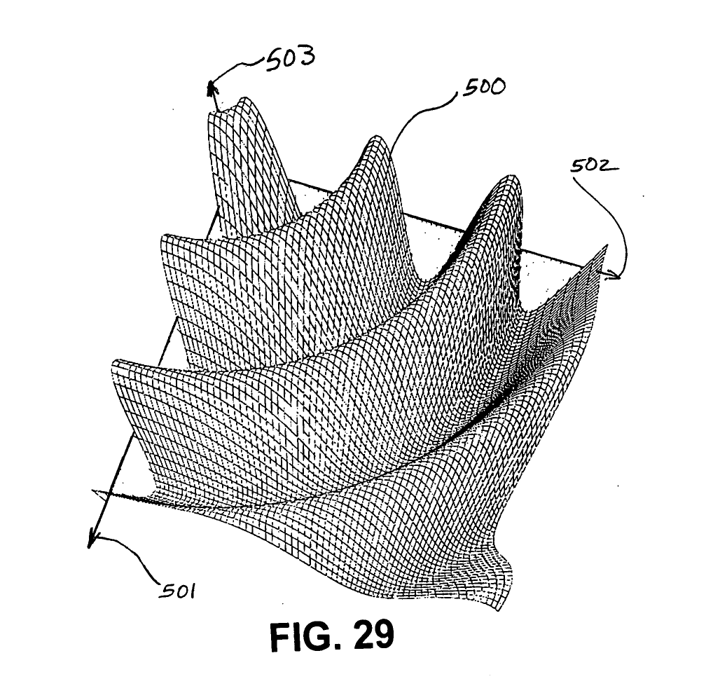

FIG. 29 shows three-dimensional plot of a mathematical description of an elastic polymorphic surface membrane.
500. A mesh pattern of the mathematical surface
501. The X-axis of the plot
502. The Y-axis of the plot
503. The X-axis of the plot

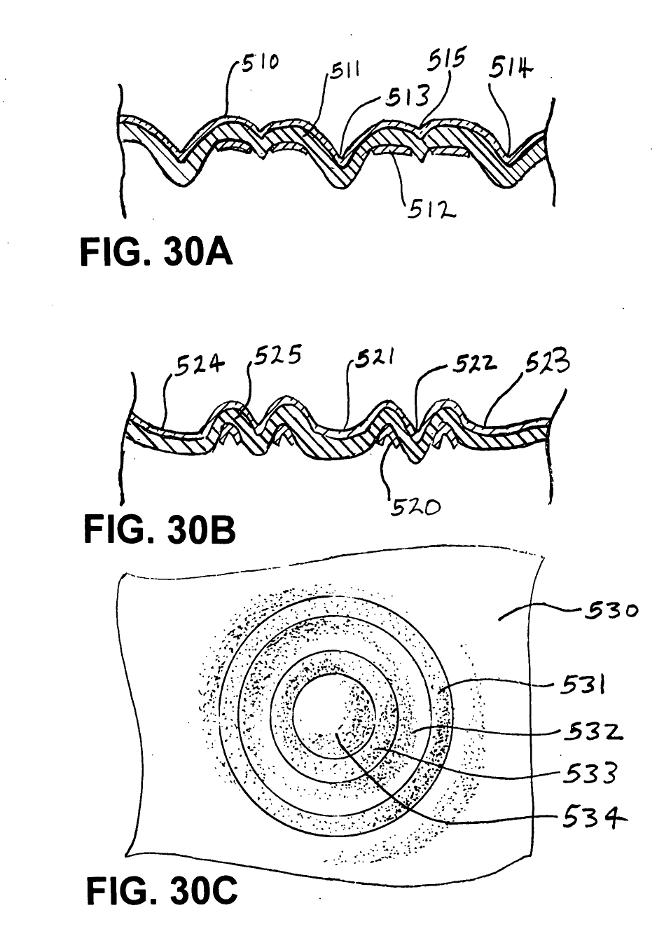

FIG. 30A shows cross-sectional view of the un-actuated bi-material polymorphic surface.
510. Teflon coating
511. Substrate
512. Actuator coating
513. Central dimple
514. Circular dimple
515. Circular dimple

FIG. 30B shows cross-sectional view of the actuated bi-material polymorphic surface.
520. Actuator material contracted
521. Central dimple
522. Bent dimple
523. Flattened dimple
524. Teflon coating
525. Substrate

FIG. 30C shows underside view of the actuated bi-material polymorphic surface.
530. Substrate
531. Actuator deposit
532. Dimple
533. Actuator deposit
534. Central dimple

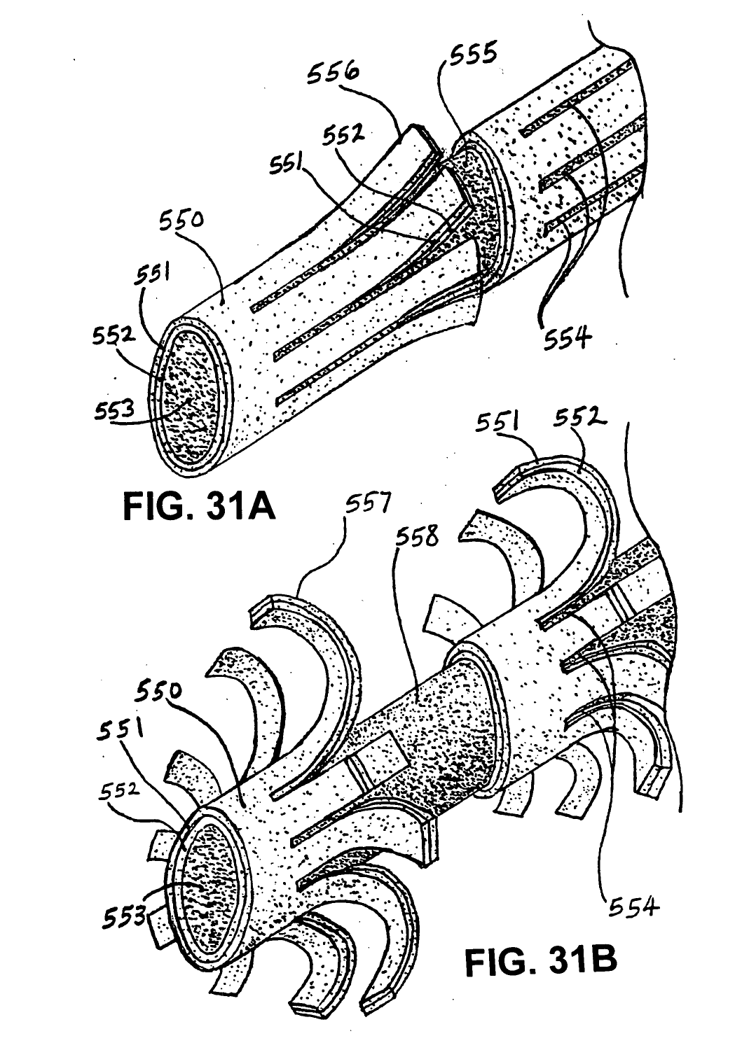

FIG. 31A Actuators on fiber in low stress, actuator down mode.
550. Outer coating high expansion coefficient reflective surface.
551. Outer coating shown on side.
552. Inner coating low expansion coefficient
553. Light absorbing substrate fiber.
554. Channels cut through the coatings.
555. Separation cut channel showing release film and dark substrate fiber.
556. Actuators on fiber down-mode.

FIG. 31B Actuators on fiber in high stress, actuator up-mode.
550. Outer coating high expansion coefficient reflective surface.
551. Outer coating shown on side.
552. Inner coating low expansion coefficient
553. Light absorbing substrate fiber.
554. Channels cut through the coatings
557. Actuator element curled up.
558. Surface of dark substrate fiber and release film revealed.

In FIG. 1A a cross-sectional view of a bi-material actuated flap valve is shown. This actuator is formed by depositing a hydrophilic and expanding solid polymer electrolyte 2,7 such as sulfonated styrene-(ethylene-butylene)-sulfonated sytrene (DAIS electrolyte solution 10% (sulfonated styrene-(ethylene-butylene)-sulfonated styrene) is dissolved in 76-79% 1-propanol 10-15% 1,2-dichloroethane, 1% cycloheaxane (DAIS-Analytic Corporation 11552 Prosperous Drive, Odessa Fla. 33556, DAIS 585), or perfluronated ion exchange polymer electrolyte such as Nafion (5% Nafion in 1-propanol, Solution Technology Inc. P.O. Box 171 Mendenhall Pa. 19357) onto a substrate 1,6 such as an insensitive to water 9-micron thick porous polyethylene (Setala® ExonMobil Chemical Co., Business and Research Center, 729 Pittsford/Palmyra Road, Palmyra, N.Y. 14502) or porous polyimide membrane (Ube Industries Ltd. Business Development Electronics Materials Dept., Specialty Products Division, Seavans North Bld., 1-2-1, Shibaura, Minato-ku, Tokyo 105-8449 Japan). The DAIS solution can be further diluted with 10 parts to 1 with 1-propanol such that the mixture to be spray deposited. The substrate membrane 1 can be corona discharge treated in air to insure a better adhesion to the surface of the plastic membrane. The dilute polymer resin mixture is sprayed with an airbrush with nitrogen gas onto the surface of the substrate membrane 1,6 and dried. The sprayed on film thickness 2,7 can be adjusted to give the actuator more or less mechanical actuation strength by adjusting the thickness of the coating. A typical thickness is 9-microns. After the hydrophilic polymer film 2 is coated onto the substrate the film is air-dried at 20% relative humidity and 22° C. The sheet is then cut with a razorblade cutter to form a rectangular aperture 3 and flap (1,2). In operation the actuator receives moisture 4 by diffusion into the hydrophilic polymer 2 from the air and the hydrophilic polymer 2 swells. The swelling of the hydrophilic polymer 2 creates expansion pressure and the bi-material structures (1,2) reacts to the pressure by curling. This curling opens the flap of the aperture and allows gases 5 to flow or diffuse though the aperture. It should be mentioned that the polymers used ior both the substrate and the expansion polymers could be crosslinked by radiation or chemical reactions to increase the modulus of elasticity and reduce their solubility. This crosslinking can be done to increase the stiffness of the system and increase the force output of the actuators.

In FIG. 1B the single flap valve of FIG. 1A is shown in perspective view as a cutout of a larger sheet. In this view the flap valve 10 is shown curled and opening the aperture 15. The actuator and flap valve is formed by the bi-material sheet 16, 17 cut to form the flap 10,11 and the aperture 15. The two layers of the bi-material are visible on the flap the substrate layer 10 and the hydrophilic expansion and contraction layer 12. The same bi-material layer can be seen in the cutout of the aperture substrate layer 13 and the hydrophilic expansion and layer 14 in the expansion mode curling the flap 10.

In FIG. 2A a cross-sectional view through an array of flap valves with temperature and humidity actuation is shown. The substrate material 23 can be made out of 10-micron thick polyester (Melinex®, DuPont Teijin Films US Limited Partnership, 1 Discovery Drive, PO Box 441, Hopewell, Va. 23860), 10-micron thick polyimide (Kapton® DuPont Films HPF Customer Services, Wilmington, Del. 19880, and 10-micron thick polyaramid (Asahi-Kasei Chemicals Corporation Co. Ltd. Aramica Division, 1-3-1 Yakoh, Kawaski-Ku, Kawasaki City, Kanagwa 210-0863 Japan). A print-sprayed deposit of a high coefficient of expansion material such as a 10-micron thick film of low-density polyethylene 24 is deposited onto the substrate material 23. Then a high coefficient of humidity expansion material 22 such as DAIS is deposited on top of the high thermal expansion coefficient material. The array is shown with the flaps 20 curled and opening an aperture 21 due to either or both higher temperatures or higher humidity due to the thermal expansion layer 24 expanding or the humidity-expanding layer 22 expanding. It is possible to form many layers of print-like deposits 24, 22 of material varying the thickness and position to form the actuators on a substrate 23.

In FIG. 2B a bottom surface view of an array of four rectangular flap valves is shown. The flap valves are formed by printing a square pattern 30 low-density polyethylene (Polyethylene films(ExonMobil Chemical Co., 5200 Bayway Drive, Baytown, Tex. 77520-2101) with a high thermal expansion coefficient and then a high humidity expansion coefficient material such as DAIS. By coating in a pattern only the area of the base areas 30 of the flap 32 the actuation of the flaps does not cause the surrounding substrate material to curl and thereby remains the flat aperture frame of the array of apertures 33, 35, 36, 37. The flap valve actuators are die cut, water jet cut, or with a laser cut onto the sheet by three straight line cuts 31 in the substrate. This allows the flap valve 32 to create an opening 33,35,37,36 in the substrate 34 when curled with a change in temperature or humidity.

In FIG. 3A cross-sectional views through a flap valve with differential temperature and humidity actuation and piezoelectric substrate is shown. The construction of the device starts with a membrane of approximately 10 microns thick substrate of stressed polychrolofluroethelyene PDVF 41, 43. This material can be poled in an electric field when stretched to be highly piezoelectric. A porous high expansion thermal coefficient material such as polyethylene 40, 44 is deposited in a rectangular pattern on the substrate 41, 43. A high humidity expansion coefficient materials and electrolyte such as Nafion or DAIS 46, 47 are deposited in a rectangular pattern on the substrate 41, 43. An electrode 45,48 made of electrical conductors such as nickel, tin, tin oxide, doped silicon, carbon, molybdenum, palladium, platinum, copper, or gold is plasma sprayed or vacuum sputter deposited onto the surface of the substrate 41, 43, high thermal expansion coefficient material 40,44 and the high humidity expansion coefficient material 46,47. The flap valve 41 and aperture 42 is then formed by cutting from the substrate 43 with a die or laser. The flap valve 41 is actuated by a difference in temperature, humidity on either side of the flap valve. This is due to either the high humidity expansion coefficient material on one side expanding more in a higher humidity than its corresponding actuator material in a lower humidity on the other side of the substrate and flap. This flap 41 can be actuated by a difference in temperature due to either the high temperature expansion coefficient material on one side expanding more in a higher temperature than its corresponding actuator material in a lower temperature on the other side of the substrate and flap. When the flap 41 is actuated and electric potential is created by the stress of the bending of the flap piezoelectric substrate material 43. This potential can be collected through the coatings 47,40,44,46 or can be collected from the direct contact of the electrode 45, 48 on the substrate material 41. The voltage output on the electrodes 45, 48 can be used to as an aperture status indicator for an electronic readout of the position of the flap 41. The actuator can also be actuated by putting a voltage on the electrodes and inducing a voltage in across the piezoelectric substrate 41, 43. It should be mentioned that the substrate 41, 43 does not necessarily need to be piezoelectric and could be a dielectric with a voltage between the electrodes 45, 48 can result in change in voltage when the actuator materials expand or contract. The actuator can be oscillated by alternating the voltage across the electrodes 45, 48. This differential actuator could be used when it is useful to open the aperture when there is a temperature or humidity difference on either side of the substrate material 41, 43.

In FIG. 3B the underside view of the differential actuator is shown. The high thermal expansion coefficient material and high humidity expansion coefficient materials are shown deposited on the substrate as a rectangle 53 on the hinge area of the flap 52. The flap 52 and aperture 51 are die cut or laser cut out of the substrate membrane 50. The electrode 55 is printed onto the surface of the layers of high thermal coefficient of expansion 56 and high humidity coefficient of expansion materials 53. The electrodes go off to electronics 54 to either sense the voltages on the actuators or impress voltages onto the actuators. In operation the actuator curls, opens the flap 52 and opens the aperture 51 allowing fluids, such as air, to flow through the aperture, or to allow gases such as water vapor to diffuse through the aperture 51.

In FIG. 4A a cross-sectional view of a differential actuator with separate humidity or thermal actuation and piezoelectric actuators is shown. In this system piezoelectric material such a s PDVF polymer or ceramic 61, 68 is deposited on the substrate material 63, 66 such as polyaramid or polyester plastic substrate film. Electrodes of gold, graphite, silver, or copper 60, 67 are powder deposited onto the piezoelectric film 61, 68 by powder spray deposit with a carrier fluid, sputter deposited, vacuum evaporated, or plasma spray deposited. High humidity or temperature coefficient of expansion materials 62, 64 are deposited onto a separate hinge area of the flap valve by spray deposition with a solvent or plasma spray deposition. DAIS electrolyte a high humidity coefficient of expansion material can be deposited by dissolving one part 10% DAIS solution (Sulfinated butyl rubber and polystyrene with proprietary solvents) in 10 parts isopropanol. The solution is then airbrush sprayed onto the substrate 63, 66 though a mask. The deposit is air-dried. As an example of a thermal expansion material polyethylene is deposited with pressure driven hot liquid sprayed polyethylene 62, 64 deposited through a mask onto both sides of the polyaramid or polyester substrate 63, 66. The deposits of expansion and contraction materials 62, 64 can use different thickness and can be only on one side of the substrate as needed to create different actuation responses. When the deposits of humidity or temperature materials 62, 64 are on a single side they will cause actuation proportional to the temperature or humidity on that side of the substrate membrane. When the deposits are on either side of the membrane the actuation will be proportional to the difference of temperature of humidity on either side of the substrate membrane 63, 66. The polyaramid or polyester substrates 63, 66 can be roughened to have a higher adhesion to the deposited films and flame treated or oxygen ion milled to increase adhesion of surface deposited films.

In operation the expansion of the high temperature expansion coefficient material 62, 64 or the humidity expansion coefficient material due to an increase in temperature or increase in humidity causes the actuator 63 to curl. This curling opens the aperture and allows fluid flow (gas or liquid) or diffusion of molecules to diffuse though the aperture 65. Reductions in the humidity or temperature can cause the expansion materials 62, 64 to contract and cause the actuator to curl in the opposite direction causing the aperture to open and allow fluid flow through the aperture or diffusion of molecules through the aperture 65. If the expansion materials are deposited on either side of the substrate material 63, 66 the expansion or contraction actuation can be proportional to the difference in temperature or humidity across the substrate material 66 and flap 63. The piezoelectric actuation can create a stress in the piezoelectric material coating 61, 68 when there is a voltage in the electrodes 60, 67 and the flap 63 curls. This can be used to electrically drive the flap valves open or closed and with an alternating current oscillate the flap valve 63 that can pump fluid through the flap valves.

In FIG. 4B and underside view of the flap valve is shown. The patterned deposits of the electrodes 70, and high coefficient of temperature or humidity expansion materials 72 are shown as rectangular deposits on the hinge region of the flap actuator 73. The patterned deposits 70, 72 are made on a flat membrane substrate material 75 and subsequently flap aperture 74 are cut 71 from the substrate with a die cut or laser.

In FIG. 5A a side view of a stack of actuating apertures 80, membranes are shown. By placing layers of actuators 81, 83, 84 thermal insulation and diffusion insulation can be obtained and the combined effect of redundant opening apertures if any single aperture fails to open or close next layer will have working apertures. This type of layering of opening or closing apertures could be used such as thermal insulation the apertures 80 open when temperatures are low thereby expanding the thickness of the air, or fluid gaps between the layers 81, 83, 84 and increasing the air volume between each layer and thereby increasing the thermal insulation. This type of material can be use in products such as sleeping bags where it is desirable to increase the thermal insulation when the temperatures are low.

In FIG. 5B the layers of stacked aperture membranes 91, 92, 93 are shown with the actuators 90 closed. The fluid or air volume between the layers is decreased with the subsequent reduction in thermal insulation.

In FIG. 6A a system of membrane actuators 104 in between two outer aperture membranes 101, 106. The actuator membrane 104 is formed with patterned coatings on either side of the substrate membrane 104 (etched nuclear particle track membrane with a fiber backing (Oxyphen PO Box 3850, Ann Arbor, Mich. 48106), depending on what kind of actuation they are coated with; humidity expansion membranes 104 or temperature expansion membranes or both. Patterned deposits 111 can be rubber materials such a neoprene, or silicone rubber. Holes or apertures 108 are formed in the actuation membrane 104 such as and the two outer membranes 106, 101 with lasers, or die cutting. The arrays of actuator membranes 104 and aperture membranes 106, 101 are arranged so that holes 100, 108, 107 in the membranes do not line up directly, as shown in FIG. 7. When the actuators 105, 102 are actuated due to either temperature or humidity changes the actuators 105, 102 curl the central material 104 into alternating curls. This wavy curling of the substrate material 104 pushes the two outer aperture membranes 101, 106 apart from the inner membrane. This separation 109,110 effectively opens the valve for fluid flow 103 or diffusion of molecule though the apertures 100, 108, 107.

In FIG. 6B the closure of the layers of actuator membrane 124 and the outer aperture membranes 121, 128 is shown. The actuator membranes 124 are flat and the sealing apertures 120, 127 are pressed against the sealing coatings 119, 129 of the actuator membrane 124. Mechanical force to seal the membranes could come from the pressure across the membrane stack 121, 124, 128 or the membranes 121, 124, 128 could be bonded or welded to the outer membranes at the expansion film points 122, 125. When the layered system is flat the apertures 120, 123, 127 are sealed and fluid flow or diffusion of molecules is blocked. An example of the use and design of this type of layered membrane system could have a hydrogen absorbing expansion and contraction material 122, 125 that when hydrogen is present the membrane expands letting hydrogen gas flow or molecules 103 through, shown in FIG. 6A. When hydrogen gas is not present the membranes 121, 124, 128 flatten out and the valve is closed. Alternatively if the placement of the hydrogen expansion material 122, 125 would be placed at the sealing layer deposit position 111, so when hydrogen concentration is high the hydrogen expansion material 111 expands flattening the membrane and sealing the system. In this case the other patterned layer deposit 105 could be used to tension the membrane into a curl and or be the bond between the outer membranes 101, 104, 106. Examples of this type of actuation could be used for humidity source regulation, methanol fuel supply regulation to a fuel cell, or oxygen and humidity regulation to zinc air batteries.

In FIG. 7 a pattern of offset apertures 132 of the valves apertures 130 is shown. These valve apertures could be organized to offset or a random pattern. The underlying apertures 132 are shown offset from the upper layer apertures 130.

In FIG. 8A a membrane actuator of a sheet 140 is shown. This actuating sheet 141 is formed by coating on alternate sides of the membrane substrate material 140 such as 10-micron thick polyester, polyaramid, or polyimide, with rectangular patterns of expansion material 142, 143, 144 such as 10 microns of DAIS or Nafion or a thermal expansion material such as polyethylene. The layers 143, 142, 144 can be deposited flat at a particular temperature or humidity. The substrate membrane sheet material 140 is die or laser cut with parallel lines between the rectangular deposit patterns 142, 143, 144. When the expansion films 143, 142, 144 are exposed to low humidity or low temperatures, compared to the flat construction, the expansion films contract 143, 142, 144. This leads to the curling as shown 143, 142, 144. Alternately the actuation can be set in the opposite direction by building the expansion layers 143, 142, 144 to be unstressed at low humidity or when condensation of water occurs and the temperatures are high compared to the construction conditions. The actuation can also be set to be opened at either high or low humidity or temperature.

In FIG. 8B the underside of the actuator sheet 150 is shown. The parallel die or laser cuts 151, 153 are shown on either side of the rectangular printed expansion material 152.

In FIG. 9 a pattern of hexagonal curling actuators 161 apertures is shown. The cut patterns are shown as 5 out of 6 sides of the hexagons 160. These patterns would be die, water jet, or laser cut out a bi-material sheet 169, 163 such as 25-micron thick high coefficient of expansion polyethylene and 25-micron thick polyester. This membrane 169 could be used as a barrier in apparel. When the temperatures rise the apertures open and let air flow though the apparel. Another application is for building ceilings, or tent ceilings, that when the top of the tent is hot, the actuators 161 open and ventilate the tent or roof. When temperatures are low the actuators 161 close and block air and heat flow out of the top of the roof or tent.

In FIG. 10 a pattern of rectangular curling actuator sheet 172 is shown. The cut patterns 170 are show as three sides out of square. The square flaps 171 are formed by the interior area inside the three cuts 170. The substrate membrane 172 forms a matrix 173 of interconnecting webs by the non-flap part of the sheet. The sheet 172 is a bi-material membrane. An application of this membrane is if the bi-material uses a high humidity expansion coefficient material and a non-humidity expanding material the flap valves 171 will actuate with higher humidity or condensing water onto the membrane 172. A possible application is as a ceiling ventilation for bathrooms that will open the ceiling to allow hot moist air to go out ventilation vent, but then block air flow once the humidity drops preventing excessive ventilation of the bathroom and heat loss.

In FIG. 11 a pattern of crossed cuts in a bi-material membrane is shown. This patterned “X” cut 180 creates triangular flap valves 181 by cutting a bi-material membrane 182. The array of flap valves 182 form a matrix of valves held together by the intersection areas 183. Coating the temperature actuating bi-material membrane 182 with a thin 100-nm aluminum reflective coating can create a possible reflector application. This bi-material 182 can be set to be open at 25° C. and when the temperature goes above roughly 35° C. the reflectors close creating a reflector to light. This type of reflector can effectively act as a sunshade or diffuser for windows when direct sunshine is overheating the room.

In FIG. 12 a pattern of three crossed cuts 190 in a bi-material membrane is shown. These three crossed cuts 190 form a matrix of triangular bi-material flaps 191. The interconnecting matrix of material 193, which holds the matrix of flaps 191 together, is hexagonal web 192. The hexagonal web 192 has a mechanical feature of being flexible in all directions in the plane of the web 192. Thus, this aperture array may be suitable for actuating barriers in clothing where flexibility is important.

In FIG. 13 a pattern of two cuts 200 in a bi-material membrane 202 is shown. The resulting flap valves 201 are triangles and the matrix of web 203 holding the flap valves are three overlapping grids each at 45 degrees to each other.

In FIG. 14A a cross sectional view of an actuator 210 that incorporates an expansion material 212 in a matrix of a material 213. A possible substrate membrane 210, 214 is a 10-micron thick polyester film. Silicone rubber monomer, Nylon® (DuPont polymers PO Box Z, Fayetteville, N.C. 28302), or urethane rubber monomer (Stevens Urethane, 412 Main Street, Easthampton, Mass. 01027-1918) 213 are mixed with inclusion material 212 such as small crystals 5 microns or smaller of a salt such as sodium sulfate, fumed silica, silica gel, fiberglass, hydro-gels (Polyacrylamide, Western Polyacrylamide Inc., PO Box 1377, Jay Okla. 74346), or bentonite clay, or any combination of these. The mixture 212, 213 is deposited onto the surface of the polyester that has been pre-treated by ion milling or an ionizing flame to promote adhesion. Inclusion material 212 can also be included in substrate material 210 either by filling pores in the substrate 210 or in incorporated when the substrate film 210 was formed. The rubber films 213 are deposited approximately 10 to 50 microns thick. The salt particles 212 should be encapsulated in the rubber film 213. The rubber films 213 are cured. The actuator 210 is die or laser cut 211 from the sheet 214 to form flap actuators. In operation the actuator receives moisture that diffuses through the high permeability of the silicone rubber or the urethane 213. The inclusion materials 212 absorb the water and swell. This swelling causes the containing membrane 213 to expand, this in turn creates a sheer stress that can be relieved by the flap actuator curling. The curling actuator flap 210 opens the aperture 211. By opening the flap valve 210 fluids can flow through the aperture 211 or diffusion of molecules can occur. Other examples of possible materials that could be incorporated and the expansion matrix 212, 213 could be precise melting point waxes or polyethylenes that when they melt cause a volume change and subsequent expansion and actuation.

In FIG. 14B a cross-sectional view of the actuator 220 with an encapsulated expansion material 222 when the expansion material 222 is contracted. The expansion material 222 is contained within the encapsulating film 223. The substrate material 220, 224 is shown flat and the flap slit 221 separates the flap 220 from the substrate membrane 224. The flap valve 220 is closed blocking fluid flow and molecular diffusion.

In FIG. 15 the cross-sectional view of the sole of a shoe is shown as an example of how an actuating valve could be incorporated into shoes. The heel of the shoe is formed by three components. The first component is the tread 234 of the sole. It is molded out of synthetic rubber and has tilted vent channels 236 with a space for the vent flaps 235 to let gas pass around the actuated flaps 235. The second layer 237 is an array of bi-material that has been pattern coated and cut to form flap valves 235. A coating 238 on the polyester substrate of high humidity expansion coefficient DAIS is located on the hinge area of the actuation flaps 235. The third layer of the sole 230 is a urethane foam rubber pad in the shoe that has been molded with walls 232 separating channels 213, 233 that are tilted opposite to the tread layer channels 236 and have multiple channels. These multiple channels 231, 232, 233 form a sealing surface for the flap actuator 235. In operation the bi-material actuators 235 open when there is high humidity in the shoe. The opening of the flaps 235, 238 permit air to flow around the flaps 235 and remove moisture. The flap valves 235 can act like one way valves to permit air to flow out through the shoe down to the ground but block air, dirt, or water flowing from the ground. Many road surfaces have hot air next to them thus is preferable to effectively pump air out through the sole of the shoe 230, 237 234 when the sole of the shoe and the impact of the foot compresses the pad 230 of the shoe, rather than push hot air up through the sole of the shoe. In operation when the heel of the foot is lifted the pad 230 of the shoe expands. This increase in volume draws humid air from the upper part of the shoe and sock around the foot. The flap valve 235 is closed due to the drop in pressure in the pad channels 231, 233. When the foot strikes the ground again the shoe pad 230 is compressed and air flows out through the flap valves 235. If airflow is dry the flap valves 238 are actuated closed and resist the air flow and heat loss from the foot. And when the airflow is moist the flap 235 is open for maximum air and heat flow. The foot is then lifted and the cycle repeats itself. If liquid water is squishes up through the bottom of shoe tread channels 236 the flap valves 235 closes due to the inertial impact of the water on the flap valves. The materials of the flap valves 235 and the channels 230, 231, 232, 233 of the pads can be made with hydrophobic surfaces to also repel liquid water and can be electrets electrostaticly charged such that will hold or repel dust and bacteria on their surfaces. It is a possibility if the actuators 235, 238 are piezoelectric as shown in FIG. 3A that they can change the electric charge on their surface to shed or attract dirt through the walking or running cycle, thus used to clean the shoe, and with attached electrodes generate a small amount of electric power. A hydrophilic coating such as titanium dioxide 239 incorporated in the channels of the tread to create a surface tension gradient to preferentially wick water to the outside of the sole 234. The titanium dioxide coating 239 with interaction with light can act as a disinfecting surface to bacteria and viruses. Silver coatings 239 can also be used as an antimicrobial coating on the surfaces of the channels 241, 236, 231, 233. The tilting of the air flow channels 236, 231, 233 between the tread layer 234 and the pad layer 230 creates a baffled air flow or in this drawing FIG. 15 a chevron structure to prevent sharp objects penetrating up through the air flow channels 236, 231, 233. Many other types of channels such as side lateral vents 241 and vents that return flow up 240 could be created. The tilt of the tread channels 236 and pad channels 231, 233, 240 direction, and placement of the channels in the rubber can modify the elastic directional behavior of the sole of the shoe to absorb some of the forward motion impact energy of the shoe and return the energy and circulate air flow to the foot when the shoe is lifted. This type of elastic and inelastic directional energy along with the control of air flow and absorption with the tread of the shoe or apparel can be useful to make the apparel more energy efficient, comfortable and ergometric for the user.

In FIG. 16 cross sectional exploded view of an assembly of the sole of the shoe is shown. In this diagram four layers are shown the tread 258, valve membrane 253, elastic pad 251, and the cloth pad 250. The tread layer 258 is molded with synthetic or natural rubber to have a tread pattern to obtain a traction pattern on the ground and provide a desirable pressure load distribution for the foot. Tilted channels 257 for air flow through the tread are created and air flow channels 257 for lateral flow of the channels are created in the molded part. Cavities 259 to allow the flap valves 254 to swing open are created in the molded tread part 258. The next component is the flap aperture membrane 253 formed out of polyester membrane and a lamination of polyethylene for thermal actuation or coatings such as DAIS for humidity actuation. The apertures 256, flap valves 254, and remaining area 255, 253 is printed or laminated and cut to match the aperture pattern of the tread 257 and the elastic pad apertures 252 above it. The third layer in the sole is the elastic pad 251. This layer is made of foamed urethane rubber or other suitable rubbers. Smaller tilted airflow channels 252 are molded into this layer that mate with the flap valves 254. The flap valves can cover the apertures of the smaller channels 252 in the airflow channels of the elastic pad 251. This covering of the flow channels 252 of the elastic pad and swing opening space 259 for the flap into the tread layer 258 creates a one way valve that will allow bursts of air to flow from the interior of the shoe and out through the sole but not through the sole into the shoe. The next layer is the fabric pad 250 made of Cool Max polyester and Lycra that covers the elastic foam pad 251. The fabric pad 250 is a wicking layer for seat and contact surface with the human skin or socks. The fabric pad 250 is porous and acts like a gas flow diffuser to flow and diffuse air under the foot. The assembly of layers are bonded to each other with appropriate glues or welding and formed as the bottom of a shoe with sidewalls as shown in FIG. 25 sewn or bonded on.

In FIG. 17 the underside of the shoe sole 270 is shown. The tilted airflow channels 271, 274 and the tread material is shown. The tread 272 of the shoe in the ball of the foot area has tilted air channels 271 and tread channels 276. Air and water can flow laterally along the tread channels 276 between the tread lines 272. A raised area of the tread for extra traction such as the tip 270 of the tread can be molded into the tread. The tilting of the channels 271 can be different such as in the channels 273 in the arch area of the shoe because of less contact with the ground and reduced elasticity needed and thinner area of the sole. In the heal region of the sole the tilted air flow channels 274 are placed between the tread ridges 275.

In FIG. 19A an arrangement of the transverse aperture opening with the actuation of the folds 301, 308 in the sheet is shown in cross-section. In this drawing the apertures 310, 303 are shown aligned. In this design there are alternating temperature or humidity actuating folds 301, 308 in one of two parallel sheets. The sheets 309, 305 can be periodically connected at the edges of the folds. The folds 301, 308 have alternating coatings of high coefficient of expansion material 307, 302 coated to the inside and outside of the folds 306, 300. Thus, when the expansion material 307, 302 expands it caused one fold 308 to un-curl and the next fold to curl 301. These mechanical actions in turn causes the aperture array 303, 310, 309, 305 between the folds 308, 301 to move laterally. The two aperture plates 309, 305 can be designed such that the apertures 303, 310 are aligned in one position and flow of fluid or diffusion 304 can occur. This arrangement of alternating curling and uncurling folds 308, 301 has the advantage that there is no net displacement of the sheet material with the expansion and contraction and that the aperture openings and closing can be larger or smaller than the actuator. The lateral opened and closed aperture sheets 309, 305 can withstand high flow forces on the apertures 303, 310 without forcing aperture plates 309, 305 to change position.

In FIG. 19B the transverse actuation of the folds 321, 326 is in the aperture plates 328, 324 are in the close position as shown in cross-section. The right hand side actuator material 325 on the substrate 327 has expanded opening the fold 326 and the left-hand side actuator material 322 has expanded closing the fold 320, 321. In this view the apertures 329, 323 are miss-aligned and the flow is reduced or blocked by the two sheet membranes 324, 328 sealing against each other.

In FIG. 20A a cross-sectional view of an actuated valve 341 is shown that utilizes layers of bend actuating membranes. In this illustration the actuators 353 are layered and folded 353 to create large displacements and forces to do work to open and close a slide valve 347. The actuators 338, 353, 344 can be formed as a folded cylindrical bellows substrate 352, 343 or as a membrane sheet of actuators are cut and rolled around and attached 351, 342 to the shaft 348 of the slide valve 347. The substrate membrane 352, 343 is coated with alternating coatings 338, 353, 344 ,337 on the two sides of the membranes 352, 343 to create the actuation folds in the membrane 352, 343. The membrane layers 353 are attached 342 to the shaft 348 of the slide valve by gluing. Ports 340, 345 are shown that are used to circulate a fluid such as air or water that the actuator will sense. The actuation chamber 339 is separated from the slide valve with an o-ring seal 354. The slide valve shaft 348 shown with the boreholes 347 with the shaft closed with respect to the flow channels 346, 349. When the actuation occurs as shown in FIG. 20B the actuation membranes 355, 356 expand against the folds of the substrate membrane 359 and sliding the valve shaft 357 into the open position 358. Application examples for this type of valve are: a temperature activated valve sensing water temperature; when temperatures are high it opens the valve to flow in cold water, a humidity actuated valve that when humidity is high it opens the valve to draw out water. A third example is an actuator that expands with hydrogen contact. The valve would open to reduce the hydrogen gas concentration by adding another gas or removing hydrogen gas. With the membranes being thin in the actuators they allow rapid diffusion and heat transfer into them, resulting in a rapid valve response time.

In FIG. 21 a cross-sectional view of a spiral bi-material actuator is shown. A sheet of bi-material that is pre-stressed to coil forms this actuator. An example of a temperature responsive membrane is a 10-micron polyethylene membrane 364 laminated planar 10-micron polyester membrane 365 at a temperature bellow the operating temperature. When the bi-membrane 364, 365 is brought up the operating temperature the bi-material membrane coils. As an example of a humidity sensitive membrane, a 10-micron thick porous polyimide membrane 365 is spray coated with DAIS solid polymer electrolyte 364 on one side and as the DAIS polymer 364 dries (solvent evaporates it contracts and it coils the actuator. The bi-material membrane is periodically perforated 362, 363 to provide for gas and heat transfer. The membrane is clamped into the wall of the housing 360 and in to a rotating sleeve 366 on a fixed shaft 368. This type of actuator produces rotational actuation with the bi-material membrane curling or uncurling with temperature changes, humidity or environmental changes in the fluid 370 that goes through channels 369, 367 or diffuses into the chamber 361 depending on the type of materials used in the bi-material 364, 365. With the periodic perforations 362 in the actuator and in the in the substrate 363 of the bi-material 364, 365 the spiral actuator can be more responsive to the surrounding temperature and molecular changes around it in contrast to bi-material actuators without perforations.

In FIG. 22A a woven fabric woven from bi-material actuating fibers 371 is shown. Co-extruding materials such as polyethylene or polystyrene and polyester form bi-material fibers such that one side of the fiber is polyethylene 372 and the other is polyester 373 as shown in FIG. 22B. The bi-material fiber 376, 379 reacts to changes in temperatures with the polyethylene 377 expanding or contracting more than the polyester 378 this in turn causes the fiber to bend. The bending of the fiber causes the fabric to thicken perpendicular to the plane of the fabric and shrink in the plane of the fabric. This type of fabric could be used to increase the thermal insulation of clothing and tighten the fit until the clothing is warm. These bi-material fibers 376, 379 could be twisted to achieve coiling actuation with temperature change. Materials that expand with humidity or chemical environment could be also be formed into bi-material fibers and incorporated into fabrics. Materials that expand with exposure to light or energy deposits could also be formed into bi-material fibers and into fabrics.

In FIG. 22C an example of the bi-material fiber 386, 388 formed as a long strip are shown. Cutting a bi-material membrane such as a 10-micron thick polyaramid membrane 385 coated with DAIS electrolyte 387 could form these fibers. The membrane is then cut with rolling cutters to form fibers,

In FIG. 22D a fiber 392 with a spiral bi-material coating 394 in shown. The spiral bi-material coating 394 with a difference in coefficient of expansion between the materials 391, 393 will induce a torque stress in the fiber 392 when there is a change in the actuating condition such as temperature change or humidity change. This torque stress will cause the fiber 392 to helically coil. The spiral coating 394 can be achieved by co-extruding two polymers 391, 393 and spinning the fiber while it is still soft or rotating one extrusion component about the other as they are co-extruded. Other construction possibilities are to coat the fiber 393 with a rotating extrusion machine or deposition machine. Examples of materials that could be used are a nylon or polyethylene fiber 393 extruded and wound around and polyaramid fibers 391. Another example is a low coefficient of expansion material such as metal, metal alloys, ceramics, semiconductors, refractory materials, titanium alloys, tungsten, tantalum, molybdenum, nickel, steel, carbon, silicone dioxide spiral deposit coated 394 on nylon, polyethylene, or polyester fibers 392. The pitch angle of the coating can set the degree of coiling in actuation. The coating 394 can be discontinuous pitched stripe pattern on the substrate 392 and produce a similar fiber coiling actuation. The low coefficient of expansion material coating 394 will be chosen have a lower coefficient of expansion than the substrate fiber 392. These fibers can be used in thermal insulation loft in jackets and gloves, with the unique property that they will coil and increase the air volume and thermal insulation of the loft in the jacket when cold. When the jacket insulation is warm the fibers straighten out and apparel thins and the thermal insulation decreases. If the coiling bi-material fibers are woven into a fabric they can be set to coil when cold and the fabric will shrink and thicken at low temperatures. When worn the fabric will expand when it is warmed near the body. Thus it will have the behavior of shrinking to fit and tightening to reducing heat loosing air gaps when cold. When the surrounding temperatures are high the clothing will loosen permitting air flow and moisture removal and cooling.

In FIG. 22E a fiber 398 with alternating side coatings 397 of different coefficient of expansion materials is shown. In this arrangement fibers 398 can be coated 397 on alternate sides. An example of this is to spray deposit alternating side coatings of DAIS electrolyte 397 in a solvent on to polyester fibers 398 as they are being wound between two reels. The coated fibers are dried to remove the solvent.

In FIG. 22F alternating side-coated fibers exposed to humidity are shown. The alternating side coating of DAIS 400, 402 will expand when exposed to humidity and cause the fiber 401 to bend. Bi-material fibers of this construction will have the property of bending when exposed to high humidity. These fibers can be woven into fabrics or loosely piled between other fabrics or membranes. This fiber bending can be useful in clothing that increases its insulation when exposed to moisture or condensation inside the jacket. Thus a jacket that increased its insulation when wet and reduces its insulation when dry.

In FIG. 23A a spiral bi-material wrapped or coated fiber 410 is shown and formed into a helix. The spiral coating 411 such as DAIS expanding or contracting on the on a polyester fiber 410 induces torque shear of the fiber 410, in other words a twist force in the fiber. When the fiber 410 is formed into helix the dominant effect of the twisting of the fiber 414 from the coating 415 results in a change in length of the helix 414 as shown in FIG. 23B. Helical fibers 414 can be incorporated into apparel as the loft insulation or woven into the fabric to give the apparel the thermal and or humidity reactivity.

In FIG. 24A a bi-material aperture membrane with light reflective coating covering a light absorbing membrane are shown. The bi-material 424, 425 is formed with the lamination of a 10-micron polyethylene membrane 425 heat sealed to a 10-micron polyester membrane (Melinex) or glass fiber reinforced membrane 424 and cut 427 to form curling flaps 421 and apertures. A 100-nm aluminum film 420 is sputter deposited over the polyethylene membrane 425. This reflective film 420 reflects sunlight 422 when the actuator is cold. A rubber or polyimide membrane 423 impregnated with carbon black is placed behind the aperture membranes. The backside of the actuators 424 on the polyester film could be also coated black or be impregnated with carbon black particles. This assembly is placed on the surface of buildings, automobiles, and thermal mass structure or incorporated in apparel. In some cases an air gap and glass sheet may be placed over the aperture membrane. In operation when the apertures are at a low temperature the apertures open and curl back 421 allowing light 426 to reach and be absorbed by the black inner surface 423. This exposes sunlight or light 426 in general to be absorbed in the blacked film 423 the absorption of light increases the temperature and subsequently raises the temperature of the bi-material actuators 424,425. When the temperature of the apertures 436, formed with slits in the membrane 432, is high the actuators 434, 433 close as shown in FIG. 24B and presenting a reflective surface 430 that reflects incident light 431 on the outside and blocking light 431 from reaching the blacken surfaces 435. This self-temperature-regulated albedo could be useful in regulating the temperatures of structures, vehicles, and apparel. The bi-material actuators could also be designed to actuate on humidity or both humidity and temperature. Applications could also include window curtains that maintain a moderate temperature or illumination in rooms.

In FIG. 25 the application of actuation apertures applied to shoes are shown. Actuator sheets 441, 442, 454, 448 can be place on the upper areas of the shoe where ventilation and appearance is desirable. The apertures are integrated with the other typical components of the shoes having a fabric liner 440, and fabric exterior 445 of the shoe. Other components of the shoe are laces 443, lacing loops 444, and shoe framework material 447. The shoes can have actuated ventilation built into the soles of the shoes. In this figure the tread 451, actuated aperture membrane 450, and the elastic upper sole pad 449 are viewed from the side. Different aperture patterns 452, 453, 455, 456, 446 are shown. Depending on how the actuating apertures are designed they can actuate on low or high temperatures or ranges of humidity. The actuators 441, 454, 442, 448 can also be coated on the exterior with retro-reflective micro beads to provide a reflective surfaces on the exterior of the shoe. When the shoes are cold the apertures 453, 456, 455, 446 can be closed down to retain heat energy. When the shoes are hot the apertures open to ventilate. The apertures 453, 456, 455, 446 can be designed to open when humid or when there is a difference in humidity to remove moisture and close when at low humidity or when there is difference in humidity across the membranes. The actuated apertures 441, 454, 442, 448 can have reflective and absorbing layers as shown in FIG. 24A and 24B to vary the albedo and color of the shoe depending on temperature or humidity to maintain a comfort level or appearance of the shoes.

Shown in FIG. 26A are ridge features 462 built onto the actuating membrane 460. A bi-material actuator 465, 464 is formed with 10-micron film of polyethylene 465 bonded to a 10-micron polyester substrate 464. Parallel polyester stripes 20-micron wide and 60-microns apart 463, 462 are hot melt deposited onto the surface of the polyester 464, 461. The polyester stripes 463 create a preferential bending direction in a bi-material membrane 465, 464. In operation when the membrane experiences a rise or drop in temperature the differential expansion or contraction of the two materials 465,464 in the bi-material cause a sheer stress between the layers. This stress can be relived by bending the membrane 460. The stripes 463 force the bending stiffness to be higher in the direction of the stripes so the membrane bends into the curl of the lowest stiffness. Once the bend has started, the membrane curl automatically makes the structure stiff perpendicular to the radius of the curl and the curl continues without the need of further stiffening from the stripes 462. By striping membranes 462 the actuators can be designed to curl in desirable directions and forms.

Shown in FIG. 26B groove features 472 are built into the bi-material actuator 470 formed with 10-micron film of DAIS 474 bonded to a 10-micron porous polyethylene substrate 473, 471. Parallel grooves 475 are cut 3-microns deep and 50-microns apart are laser cut or melted into the surface of the porous polyethylene 471, 473. A solid polymer electrolyte 474 such as DAIS is deposited onto one side of the grooved substrate 473. The grooves 472, 475 create a preferential bending weakness direction in a bi-material membrane 470. In operation when the membrane experiences a rise or drop in humidity the differential expansion or contraction of the two materials 474, 473 in the bi-material 470 cause a sheer stress between the layers. This stress can be relived by bending the membrane 470. The grooves 472, 475 force the bending stiffness to be higher in the direction of the stripes so the membrane 470 bends into the curl of the lowest stiffness. Once the bend has started the curl of the membrane automatically makes the structure stiff perpendicular to the radius of the curl and the curl continues without the need of further stiffening form the grooves 472, 475. By grooving the membranes the actuators can be designed to curl in desirable directions and forms. The grooves 472, 475 can be used to also limit the radius of curl when the curling closes the grooves 472, 475. It should also be mentioned that folds in the substrate could be used and also act similar to grooves as directional stiffeners. Oriented substrate materials 473 can be utilized to set the curl behavior in actuators.

In FIG. 27 a pinwheel pattern of actuation is shown cut in a bi-material membrane 480. The flap actuators 483 open on the cut 481 and hinge 482 on the side not cut. These types of patterns can be used to form decorative or esthetically pleasing actuation. The actuation can be used to spell letters and patterns that could act as indicators of temperature or humidity. The patterns can even be whimsical and entertaining. A particular application is a transparent or translucent sheet array of actuated apertures beneath a skylight in a building. The skylight shaft and sides of the skylight can also be an air vent chimney. The sheet array of actuators 480 can open when temperatures or humidity is high, ventilating the building. When temperatures and/or humidity are low the actuators 480 block airflow and insulate the building.

In FIG. 28 another pattern of actuation flaps 487 can be constructed with non-straight line cuts 486 in the bi-material membrane 488. The bi-material membrane 488 can be cut with dies into a wide variety of shapes. Possible applications are actuating artificial flowers the react to humidity changes or temperature changes. Another application is a temperature strip on the side of hot beverage cups that indicate temperature of the beverages as the actuators open. Another application is a toy that when placed in a bathtub indicates with actuators when the water is too hot or cold for bathing.

In FIG. 29 a three dimensional mathematical plot of an example of a polymorphic surface 500 (a surface of different forms). The mathematical formula is:
z=Sin((x²+y²)^{1/2}).

This mathematical surface 500 has the appearance of a wave rings encircling the origin or the X 501, Y 502 and Z 503 axis.

Our definition of a polymorphic surface is a surface that changes shape or one that a straight line may not be drawn anywhere across the surface and stay within the surface. This type of surface is elastic by bending the membrane rather than in tension or compression. The thinner the membrane the lower the bending stress thus thin membrane or fibers will not exceed the yield stress for greater amounts of bending, and no portion of the surface is in pure tension or compression. Thus this polymorphic membrane is expected to deform without yielding and elastically return to its original shape when the stress is removed. Thus it is what we call this type of surface an elastic polymorphic surface. This elastic surface has the property that when pulled in any direction the stress in the surface will be by bending rather than tension. Thus, if the material is bi-layered and stress is created from differential expansion rates of those two materials can relieve that stress by bending and not place any portion of the surface in pure tension or compression. This has the practical application of defining surfaces that are very elastic and flexible (supple). Elastic bi-material actuation of these surfaces can easily occur in any direction. Examples of elastic polymorphic surfaces woven (curved fiber) fabrics, hexagonal mesh nets, helical coils. Elastic polymorphic surfaces are only a subset of surfaces that can be actuated with bi-material actuation but represent a geometric class of forms and substrates that translate bi-material actuation into unique systems.

In FIG. 30A an example of m actuator using an elastic surface or elastic polymorphic surface is shown. The bi-material actuator is built with a dimpled fiberglass reinforced polyester 513, 515, 514 substrate membrane 511. A circular pattern of with a high thermal expansion coefficient actuator material 512 such as polyethylene plastic or crystalline polyacrylate in rings are deposited within the folds of the substrate 511. The actuator material could also encapsulate a material such as a low melting point wax (melting point: −1° C.). When the wax phase changes to a solid it contracts and causes a rapid change in shape for a small temperature change. On the exterior the substrate membrane 511 a Teflon coating 510 is deposited onto the substrate 511.

Shown in FIG. 30B the bi-material 525, 520 the actuation coatings 520 contract when it is exposed to low temperatures, such as below the −1° C. for deicing applications. This contraction leads to the folds 520, 522 with the actuator coatings to further fold and the non-coated folds 524, 521, 523 to un-fold.

In FIG. 30C the circular ring deposit pattern 531, 533 of the actuators is shown viewing the interior side of the bi-material membrane 530. The un-coated dimples 532, 534 in the substrate 530 are shown. One of the possible applications of this dimpling actuation is to act as a surface de-icer on airplane wings or windmills. The bi-material membrane can be attached to the surface of the wing with a foamed rubber glue. The foamed rubber will allow the membrane to flex. When liquid water strikes the surface of the wing and while it is crystallizing it will raise the temperature to near 0° C. and the bi-material surface will be in the dimple state of FIG. 30A. When the surface is cooled bellow the freezing point of water the membrane will deform as in FIG. 30B. and the ice will be separated from the bi-material surface and the wing. This cycle of new layer of water striking the surface, crystallizing, separating, and sloughing off, can be repeated.

In FIG. 31A and FIG. 31B an arrangement of the actuators built on a substrate fiber to cause the actuators to curl and increase the fluid flow resistance about the substrate fiber is shown. The curling of the actuators from the substrate fiber can also cover or reveal the surface of the substrate fiber. This effect can be used to change the albedo or color of the overall fiber. The curling of actuators can be used to change the fluid flow around the fibers and change heat transfer rates around or through the fibers. The following is a description of the fiber constructed for thermal change response as an example. There are many other possible layers and responses to environmental changes such as chemical and humidity environmental changes. The following construction steps are one of many possible ways to construct the actuator system.

In FIG. 31A the substrate fiber 553 is a carbon black impregnated polyaramid fiber. A selectively deposited release film 555 such as Plasma polymerized PTFE could be coated on the fiber in the area that the actuators should separate from the core fiber 553. The substrate fiber 553 and release film zone 555 are then coated with a carbon black powder loaded polyester film 552 with a solution deposit for a low or negative thermal expansion coefficient at 25° C. A high expansion coefficient film 551 of white acrylic (titanium dioxide powder loaded) is coated over the polyester film 552 with a solution deposit at 25° C. The acrylic 551 and polyester films 552 are then cut with a laser in a ring pattern to create a separation between the actuator ends 555 and spaced slits 554 to separate the parallel actuators 556. In this FIG. 31A the actuators 556 are shown in the non-stressed position, covering the dark low albedo substrate fiber 555 with the high albedo of the outer white acrylic film 550. The fiber will have the appearance of being white and skinny. The reflective high albedo can be useful if the fiber is incorporated into apparel to reflect light from the user and reduce the temperature of the apparel.

In FIG. 31B the fiber is exposed to a low temperature environment such as 0° C. The acrylic film 551 contracts and the polyester film expands 552 and the substrate fiber 553 contracts. This leads to the actuator 557 peeling off the fiber substrate 558 where there is a release agent and curling away from the substrate fiber 553. This curling of actuators 557 creates fluid flow drag around the fiber 553. The fiber 553 will visually appear to thicken. This fiber fluffing can be used in fabrics to decrease the fluid flow (gasses, air or liquids) through clothing and increase the thermal insulation properties of the clothing. The curling of the fiber also reveals the dark fiber substrate 558 and the dark polyester 552 and would give the optical effect of darkening the fiber 553. If the fiber is incorporated into apparel such as fabric or loft insulation by darkening and increasing light absorption of the apparel when it is cold the apparel can increase the temperature of the apparel. Due to the hydrophobic coatings on the fibers 558 and 552 and more hydrophilic properties of the titanium dioxide powder loaded acrylic film 551, the action of revealing the hydrophilic surfaces will make the fibers more hydrophobic, repelling liquid water and blocking it's flow. When the fibers are flattened out as in FIG. 31A the hydrophilic surfaces 550 cover the outside of the fiber 553. This would make the fibers hydrophilic and able to wick and pass liquid water across its surfaces 553.

Materials:

DAIS (DAIS-Analytic Corporation 11552 Prosperous Drive, Odessa Fla. 33556, DAIS 585).
Nafion® (5% Nafion in 1-propanol, Solution Technology Inc. P.O. Box 171 Mendenhall Pa. 19357).
Polyurethane (Stevens Urethane, 412 Main Street, Easthampton, Mass. 01027-1918).
Etched nuclear particle track membrane with a fiber backing (Oxyphen PO Box 3850, Ann Arbor, Mich. 48106).
Hydro-gel, Polyacrylamide, (Western Polyacrylamide Inc., PO Box 1377, Jay Okla. 74346).
Polyester with a negative expansion coefficient Melinex®, (DuPont Teijin Films US Limited Partnership, 1 Discovery Drive, PO Box 441, Hopewell, Va. 23860).
Porous Polyimide (Ube Industries Ltd. Business Development Electronics Materials Dept., Specialty Products Division, Seavans North Bld., 1-2-1, Shibaura, Minato-ku, Tokyo 105-8449 Japan).
Polyaramid (Asahi-Kasei Chemicals Corporation Co. Ltd. Aramica Division, 1-3-1 Yakoh, Kawaski-Ku, Kawasaki City, Kanagwa 210-0863 Japan).
Porous polyethelyene (Setala® ExonMobil Chemical Co., Business and Research Center, 729 Pittsford/Palmyra Road, Palmyra, N.Y. 14502ExonMobil).
Polyetheylene films(ExonMobil Chemical Co., 5200 Bayway Drive, Baytown, Tex. 77520-2101).
Nylon® (DuPont polymers PO Box Z, Fayetteville, N.C. 28302).
   Some essential feature elements are:
1. Actuation with bi-material or multilayered material
2. Create force
3. Create movement
4. Create displacement or structural change
5. Apertures and porous
6. Slits
7. Folds
8. Fibers, grooves and deposits to orient actuation
9. Elastic polymorphic surface
10. Actuation of apertures with bi-material
11. Bending stress actuation (sheer stress)
12. The bi-materials have large differences in thermal expansion, humidity or photo reactive coefficients.
13. Cantilever actuation
14. Fold actuation
15. Coil actuation
16. Helical coil actuation
17. Multiple layers
18. Multiple components
19. Applied to fibers and actuation of fibers
20. Alternating area coatings and patterns
21. Spiral coating (torsion stress)
22. Cantilever actuation
23. A plurality of actuators.
24. Plastic actuators, rubbers, metals, ceramics, or non-metals.
25. Small actuators.
26. Actuated apertures to be used to control diffusion.
27. Actuated aperture to be used to control fluid flow.
28. Actuated apertures or surface tilt to control light reflection, transmission, and absorption.
29. Actuation on humidity.
30. Actuation on temperature.
31. Actuation on humidity and temperature.
32. Actuation on contact with a chemical species
33. Actuation with light
34. Actuation by deposition of energy or energy differences in environment (including energetic particles).
35. Actuated by electrical stimulation
36. Simple curl actuation.
37. Compound curl actuation.
38. Cut patterns in sheet of material to induce actuation of apertures or physical separation or movements.
39. Applied to apparel.
41. Applied to shoes
42. Applied to fuel cells
43. Applied to catalytic heaters
44. Applied to scent generators
45. Applied to photo catalytic reactors
46. Applied to evaporative coolers
47. Applied to structures
48. Applied as wall paper
49. Applied to greenhouses
50. Applied to cars
51. Applied to toys
52. Applied to books
53. Applied to food packaging and containers
54. Applied to sensors and indicators
55. Applied to windows
56. Applied as sensor
57. Applied to tents and sleeping bags
58. Applied to de-icing
59. Used to control humidity
60. Used to control temperature
61. Electrodes
62. Piezoelectric
63. Ion drag and subsequent expansion or contraction.
64. Reversible and irreversible actuation
65. Interior cavity molding
66. Used as a controlled diffusion, or fluid flow source
67. Differential actuation (more than bi-layer and opposing layers)
68. Actuation due to multiple effects (humidity, temperature, light, chemicals)
69. Actuators are part of a barrier
70. Self adjusting clothing. Shrinks until warm.
71. Hydrophobic and hydrophilic surfaces or barriers
72. Electrostatic surfaces
73. Photocatalytic coatings and materials and antimicrobial

While the invention has been described with reference to specific embodiments, modifications and variations of the invention may be constructed without departing from the scope of the invention, which is defined in the following claims:

We claim:

1. An actuated mechanical structure, said mechanical structure including at least one actuator, said actuator including actuation components and formed integral to a sheet or sheets, curved surface, fiber, cylinder, sphere, polygon, or polymorphic surface of material, wherein actuation of said actuator is effected by differential expansion or contraction of two or more adjacent materials and with slit, groove, open perforation, fold, dimple, fiber, deposit, lamination, slits, grooves, pores, open perforations, folds, fibers, deposits, laminations, or dimples of the surface, wherein said actuator actuates integral apertures, creates mechanical displacement, changes structure, or creates force.

2. The actuated mechanical structure of claim 1, wherein said actuator opens and closes said apertures.

3. The actuated mechanical structure of claim 1, wherein the actuation is bending of a sheet or fiber achieved by sheer stress from the two or more adjacent materials.

4. The actuated mechanical structure of claim 1, wherein the adjacent materials have large differences in thermal expansion coefficients, humidity expansion coefficients, or photo reactive expansion coefficients.

5. The actuated mechanical structure of claim 1, wherein the actuation is cantilevered actuation, coil, helical coil, or fold actuation.

6. The actuated mechanical structure of claim 1, wherein multiple layers are used to form the actuator.

7. The actuated mechanical structure of claim 1, wherein said at least one actuator is multiple actuators or apertures.

8. The actuated mechanical structure of claim 1, wherein the actuation moves fibers.

9. The actuated mechanical structure of claim 1, wherein the actuation bends, twists, or coils fibers.

10. The actuated mechanical structure of claim 1, wherein the at least one actuator is formed into two or more material laminate fibers that actuate by bending or coiling.

11. The actuated mechanical structure of claim 1, wherein the actuation components or apertures are formed with alternating area coatings on sheets, or fibers.

12. The actuated mechanical structure of claim 1, wherein the actuation components are fibers coated or formed with a pattern to create torsion stress

13. The actuated mechanical structure of claim 1, wherein the actuation components are fibers coated or formed with a spiral pattern.

14. The actuated mechanical structure of claim 1, wherein the actuation component is a cantilevered rod, beam, sheet or fiber.

15. The actuated mechanical structure of claim 1, which includes a plurality actuators, apertures, fibers, or layers.

16. The actuated mechanical structure of claim 1, wherein said structure is formed of solids of plastics, rubbers, metals, ceramics, or non-metals.

17. The actuated mechanical structure of claim 6, wherein the actuator is made of two or more layers that are less than 1 cm thick.

18. The actuated mechanical structure of claim 6, wherein the actuator is made of two or more layers that are less than 100 micrometers thick.

19. The actuated mechanical structure of claim 1, wherein said structure is used to change or control molecular or thermal diffusion.

20. The actuated mechanical structure of claim 1, wherein said structure is used to change or control fluid flow.

21. The actuated mechanical structure of claim 1, wherein the structure is used as valves that are also actuated by pressure changes or airflow to control fluid flow.

22. The actuated mechanical structure of claim 1, wherein said structure is used to change or control light reflectivity, albedo or transmission.

23. The actuated mechanical structure of claim 1, wherein said at least one actuator is actuated by humidity, humidity changes, or humidity differences.

24. The actuated mechanical structure of claim 1, wherein said at least one actuator is actuated by temperature, temperature changes, or temperature differences.

25. The actuated mechanical structure of claim 1, wherein said at least one actuator is actuated by contact with chemicals, chemical environmental changes, and chemical environmental differences.

26. The actuated mechanical structure of claim 1, wherein said at least one actuator is actuated by electromagnetic radiation.

27. The actuated mechanical structure of claim 1, wherein said at least one actuator is actuated by deposition of energy or energy differences in the environment in time or space.

28. The actuated mechanical structure of claim 1, wherein said at least one actuator is actuated by electrical stimulation.

29. The actuated mechanical structure of claim 1, wherein said at least one actuator actuates into a curled shape.

30. The actuated mechanical structure of claim 1, wherein said at least one actuator actuates into more than one curled shape surfaces.

31. The actuated mechanical structure of claim 1, wherein said at least one actuator actuates into shapes using apertures, folds or placement of laminate material components.

32. The actuated mechanical structure of claim 1, wherein said at least one actuator is applied to apparel, shoes, fuel cells, catalytic heaters, scent generators, photo catalytic reactors, evaporative coolers, structures, wall paper, greenhouses, cars, toys, books, food containers, sensors, indicators, windows, de-icing, sleeping bags, chemical environment control, for humidity control, or temperature control.

33. The actuated mechanical structure of claim 1, wherein said at least one actuator is formed with electrodes.

34. The actuated mechanical structure of claim 33, wherein said at least one actuator is formed also with piezoelectric actuation.

35. The actuated mechanical structure of claim 33, wherein said at least one actuator is formed also with piezoelectric element and can produce electrical output, create light, attract or repel dust, or change surfaces or bodies.

36. The actuated mechanical structure of claim 33, where in said at least one actuator is formed also with actuation using ion drag in electrolytes.

37. The actuated mechanical structure of claim 33, wherein said at least one actuator is formed also with actuation that is reversible or irreversible.

38. The actuated mechanical structure of claim 1, wherein said structure uses interior cavity molding.

39. The actuated mechanical structure of claim 1, wherein said structure is used as part of a controlled diffusion or flow of a chemical, chemicals, or humidity.

40. The actuated mechanical structure of claim 1, wherein the structure uses multiple layers to actuate on differences in environment across the actuator, or differences in environmental contact time with the actuator.

41. The actuated mechanical structure of claim 40, wherein the actuation can occur from more than one environmental factor of humidity, temperature, light, chemicals, or electrical energy deposit.

42. The actuated mechanical structure of claim 1, wherein said structure is formed as part of a barrier blocking heat, light, chemical diffusion or fluid flow that with actuation changes the barrier properties to remodify flow of heat, light, fluid, or chemicals.

43. The actuated mechanical structure of claim 1, wherein said structure adjusts its dimensions with an object until an equilibrium with the objects surface contact pressure, temperature, heat flow, humidity emissions, chemical emissions, light emissions, electrical emissions, or energy emissions is reached.

44. The actuated mechanical structure of claim 1, wherein said at least one actuator incorporates hydrophobic and hydrophilic surfaces.

45. The actuated mechanical structure of claim 1, wherein said at least one actuator incorporates electrostatic surfaces or electrets.

46. The actuated mechanical structure of claim 1, wherein said at least one actuator incorporates hydrophobic, electrostatic, and hydrophilic surfaces.

47. The actuated mechanical structure of claim 1, wherein said at least one actuator incorporates photocatalytic coatings or antimicrobial materials.

48. The actuated mechanical structure of claim 1, wherein said at least one actuator incorporates hydrophobic, electrostatic, hydrophilic surfaces, piezoelectric, and photocatalytic or antimicrobial surfaces.

49. The actuated mechanical structure of claim 1, wherein said at least one actuator is formed using ion exchange resins as one of the actuation components.

50. The actuated mechanical structure of claim 1, wherein said at least one actuator is formed using ion conductive polymer as one of the actuation components.

51. The actuated mechanical structure of claim 1, wherein said structure is formed as a humidity actuating system, and said at least one actuator uses ion conductive polymer or material as one of the actuation components such as solid polymer electrolytes of sulfonated styrene-(ethylene-butylene)-sulfonated sytrene, perfluorinated ion exchange polymer electrolyte, cellulose acetate, crosslinked sulfinated polymers or rubbers, nylon, polyacrylates, urethane, and hydro-gel, and the low humidity expansion coefficient materials are metal, metal alloys, alloys, ceramics, refractory materials, ceramics, semiconductors, tungsten, tantalum, molybdenum, nickel, steel, carbon, silicone dioxide polyimide, polyaramid, fiberglass, steel, carbon fibers, carbon coating, glass, and polyester.

52. The actuated mechanical structure of claim 1, wherein said structure is formed as a temperature actuating system, and said at least one actuator uses low density polyethylene, high density polyethylene, urethanes, as one of the high coefficient of thermal expansion actuation components and the adjacent low or negative thermal coefficient of expansion materials are polyimide, polyester, polyaramid, fiberglass, steel, molybdenum tungsten, refractory materials, glass, carbon fibers, carbon coating.

53. The actuated mechanical structure of claim 1, wherein said structure is formed as a light actuating system, and said at least one actuator uses titanium oxide photo catalyst, hydrocarbons, carbon dioxide, water and zeolites, and are capable of making methanol, carbon dioxide, hydrogen and oxygen with the interaction with light photons to create a net volume change to be encapsulated in one of the adjacent materials.

54. The actuated mechanical structure of claim 1, wherein the at least one actuator is formed with electrical conductors of nickel, steel, tin, tin oxide, doped silicon, carbon, molybdenum, palladium, platinum, copper, or gold with solid polymer electrolytes of sulfonated styrene-(ethylene-butylene)-sulfonated styrene, perfluronated ion exchange polymer electrolyte, cellulose acetate, crosslinked sulfinated polymers or rubbers, nylon, polyacrylates, and with substrates of polychlorofluroethylene, polyimides, polyethylene, polyaramid, polyester, ceramics, glass reinforced polymers, fiber reinforced polymers, sulfinated polymers or rubbers.

55. The actuated mechanical structure of claim 1, wherein the at least one actuator is formed with doped silicon, carbon, platinum, tin, silver, nickel, copper, gold electrodes with piezoelectric polymer of polychlorofluroethylene, nylon, or inorganic piezoelectric material between the electrodes.

56. The actuated mechanical structure of claim 1, wherein the at least one actuator uses effects of piezoelectric, ion drag, irreversible bending, electrets, electrostatic, hydrophobic surface tension, hydrophilic surface tension, or photocatalysts.

57. The actuated mechanical structure of claim 1, wherein a moisture source is provided and moderates the flow of moisture depending on the humidity of the environment.

58. The actuated mechanical structure of claim 1, wherein said structure includes differential actuation with more than two layers.

59. The actuated mechanical structure of claim 1, wherein said at least one actuator actuates in response to more than one environmental parameter of humidity, chemical content, temperature, or light.

60. The actuated mechanical structure of claim 1, wherein said structure is formed with interior cavities.

61. The actuated mechanical structure of claim 1, in combination with an article of clothing or apparel, thereby forming self adjusting clothing or attached apparel, changing thermal insulation with temperature, changing moisture emission rate with humidity or albedo with light, changing dimensions with temperature, changing dimensions with humidity, changing appearance with temperature, appearance with humidity, changing appearance with electrical stimulation, or changing appearance with light.

62. A sheet or fiber structure, said structure being without a straight line of material across a surface of the structure in any direction, wherein said structure is formed with two or more adjacent layers with different coefficients of expansion.

63. The sheet or fiber structure of claim 62; wherein said structure is elastic by bending, wherein said structure will deform without yielding in response to stress by bending and will elastically return to its original shape when said stress is removed.
